(19) United States
(12) Patent Application Publication
(10) Pub. No.: US 2026/0361426 A1
(43) Pub. Date: Nov. 12, 2026

(54) Free Space Detection for Radio-Frequency Exposure Management

(71) Applicant: Apple Inc., Cupertino, CA (US)

(72) Inventors: Yikuan Chen, Sunnyvale, CA (US); Ioannis Sarkas, San Carlos, CA (US); Travis A Barbieri, Pacifica, CA (US); Sharad Sambhwani, San Diego, CA (US)

(21) Appl. No.: 19/339,886

(22) Filed: Sep. 25, 2025

Related U.S. Application Data
(60) Provisional application No. 63/803,231, filed on May 9, 2025.

(51) Int. Cl. H04B 17/10; H04B 17/12; H04W 52/08

(52) U.S. Cl. CPC H04B 17/104; H04B 17/12; H04W 52/08

(57) ABSTRACT

Wireless circuitry may include a transmitter, an antenna, and a sensor. The transmitter may transmit radio-frequency signals while the antenna is in an occluded state and the sensor may perform voltage standing wave ratio (VSWR) measurements to detect a transition of the antenna to a free space state. Processing circuitry may compare the VSWR measurements to a reference cluster associated with the antenna operating in the free space state. For example, the processing circuitry may calculate a Mahalanobis distance between a VSWR measurement and the reference cluster, may detect that the antenna has entered the free space state when the distance is less than a threshold, and may detect that the antenna remains in the occluded state when the distance exceeds the threshold. If the antenna is detected as remaining in the occluded state too often, an update algorithm may be performed to update the reference cluster.

This application claims the benefit of U.S. Provisional Patent Application No. 63/803,231, filed May 9, 2025, which is hereby incorporated by reference herein in its entirety.

### FIELD

This disclosure relates generally to electronic devices, including electronic devices with wireless circuitry.

### BACKGROUND

Electronic devices are often provided with wireless capabilities. An electronic device with wireless capabilities has wireless circuitry that includes one or more antennas. The antennas transmit radio-frequency signals. During transmission, the radio-frequency signals are sometimes incident upon nearby external objects such as the body of a user or another person.

Wireless circuitry is typically operated in geographic regions that impose regulatory limits on the amount of radio-frequency exposure produced by the wireless circuitry while transmitting radio-frequency signals. It can be challenging to design wireless circuitry that meets these regulatory limits while still exhibiting sufficient levels of performance.

### SUMMARY

An electronic device may include wireless circuitry. The wireless circuitry may include a transmitter and an antenna coupled to the transmitter over a transmission line path. A voltage standing wave ratio (VSWR) sensor may be coupled to the transmission line path. The transmitter may transmit radio-frequency signals while the antenna is in an occluded state. When the antenna is in the occluded state, the transmitter may be subject to a maximum transmit power level. The VSWR sensor may be used to detect a transition of the antenna from the occluded state to a free space state. The transmitter may increase its maximum transmit power level in response to detecting that the antenna has entered the free space state.

The VSWR sensor may perform VSWR measurements. Processing circuitry may compare the VSWR measurements to a reference cluster of VSWR values associated with the antenna operating in the free space state. For example, the processing circuitry may calculate elliptical distances in the complex plane such as Mahalanobis distances between the VSWR measurements and the reference cluster. The processing circuitry may detect that the antenna has entered the free space state when a Mahalanobis distance between a VSWR measurement and a center of the reference cluster is less than a threshold. The processing circuitry may detect that the antenna remains in the occluded state when the Mahalanobis distance exceeds the threshold.

When the antenna is detected as remaining in the occluded state too often, an update algorithm may be performed to update the reference cluster that is used to determine when the antenna has entered the free space state. The update algorithm may include, in an updated reference cluster, VSWR measurements that vary in phase from the previous reference cluster but that do not vary excessively in magnitude from the previous reference cluster. This may occur, for example, when a removable device case on the device has changed. If desired, an unsupervised learning algorithm may be used to generate the updated reference cluster. If desired, a validation algorithm that compares the updated reference cluster to a factory reference cluster may be performed before saving the updated reference cluster. In this way, the wireless circuitry may reliably ensure compliance with regulatory requirements on radio-frequency exposure while increasing the amount of time when signal transmission is performed without maximum transmit power limitations.

An aspect of the disclosure provides a method of operating wireless circuitry. The method can include transmitting, using an antenna, radio-frequency signals subject to a maximum transmit power level. The method can include performing, using a sensor, a voltage standing wave ratio (VSWR) measurement based on the radio-frequency signals transmitted by the antenna. The method can include adjusting, using one or more processors, the maximum transmit power level based on an elliptical distance between the VSWR measurement and a reference set of VSWR values associated with the antenna.

An aspect of the disclosure provides wireless circuitry. The wireless circuitry can include a transmitter configured to transmit radio-frequency signals over a transmission line path while subject to a maximum transmit power level backoff. The wireless circuitry can include a voltage standing wave ratio (VSWR) sensor coupled to the transmission line path and configured to perform a VSWR measurement based on the radio-frequency signals. The wireless circuitry can include one or more processors communicatively coupled to the VSWR sensor and the transmitter, the one or more processors being configured to reduce or remove the maximum transmit power level backoff of the transmitter responsive to a distance between the VSWR measurement and a reference cluster of VSWR values being less than a threshold.

An aspect of the disclosure provides a method of operating wireless circuitry. The method can include transmitting, using a transmitter while subject to a maximum transmit power level, radio-frequency signals over an antenna. The method can include performing, using a sensor while the antenna is in an occluded state, a voltage standing wave ratio (VSWR) measurement based on the radio-frequency signals. The method can include detecting, using one or more processors, whether the antenna remains in the occluded state or has transitioned to a free space state based on a comparison of the VSWR measurement to a reference cluster of VSWR values associated with the free space state. The method can include increasing, using the one or more processors, the maximum transmit power level responsive to detecting that the antenna has transitioned to the free space state. The method can include updating, using the one or more processors, the reference cluster of VSWR values to include the VSWR measurement responsive to detecting that the antenna remains in the occluded state.

### BRIEF DESCRIPTION OF THE DRAWINGS

FIG. 1 is a diagram of an illustrative electronic device having wireless circuitry in accordance with some embodiments.

FIG. 2 is a diagram of illustrative wireless circuitry in accordance with some embodiments.

FIG. 3 is a diagram of illustrative antennas in an electronic device that may be used to transmit signals and perform voltage standing wave ratio (VSWR) measurements in accordance with some embodiments.

FIG. 4 is a state diagram of illustrative radio-frequency exposure modes for an antenna, each associated with a different respective range of VSWR measurements and maximum transmit power level constraints in accordance with some embodiments.

FIG. 5 is a flow chart of illustrative operations involved in transmitting radio-frequency signals using one or more antennas of an electronic device in accordance with some embodiments.

FIG. 6 is a flow chart of illustrative operations involved in detecting a transition of an antenna from an occluded state to a free space state in accordance with some embodiments.

FIG. 7 is a portion of a Smith chart showing one example of how VSWR measurements from an antenna may be compared to a free space reference cluster of VSWR measurements for detecting a transition of the antenna from an occluded state to a free space state in accordance with some embodiments.

FIG. 8 is a Smith chart showing how an illustrative free space reference cluster of VSWR measurements for an antenna may be updated over time based on environmental conditions of the antenna in accordance with some embodiments.

FIG. 9 is a flow chart of illustrative operations involved in updating a free space reference cluster of VSWR measurements in accordance with some embodiments.

FIGS. 10 and 11 are flow charts of illustrative operations involved in validating an updated free space reference cluster of VSWR measurements in accordance with some embodiments.

FIG. 12 is a plot showing how impedance measurements performed in the presence of a non-metallic removable device case or the absence of any removable device case may fall into one of two different regions in accordance with some embodiments.

FIG. 13 is a flow chart of illustrative operations that may be performed to add measurements to occluded and free space clusters for use in cluster learning in accordance with some embodiments.

FIG. 14 is a flow chart of illustrative operations involved in using an occluded cluster to trigger reference cluster learning in accordance with some embodiments.

FIG. 15 is a flow chart of illustrative operations involved in using a free space cluster to trigger slow learning in accordance with some embodiments.

FIG. 16 is a flow chart of illustrative operations involved in performing reference cluster learning in accordance with some embodiments.

FIG. 17 is a flow chart of illustrative operations involved in performing slow learning in accordance with some embodiments.

### DETAILED DESCRIPTION

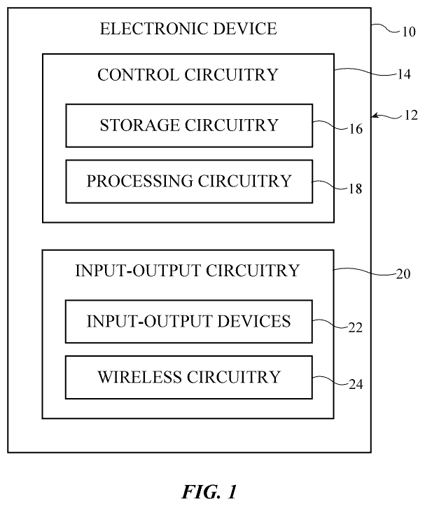

Electronic device 10 of FIG. 1 may be a computing device such as a laptop computer, a desktop computer, a computer monitor (e.g., containing an embedded computer), a tablet computer, a cellular telephone, a media player, or other handheld or portable electronic device, a smaller device such as a wristwatch device, a pendant device, a headphone or earpiece device, a device embedded in eyeglasses, goggles, a helmet, or other equipment worn on a user's head (e.g., an augmented, virtual, or mixed reality head-mounted display device), or another wearable or miniature device, a television, a computer display (e.g., that does not contain an embedded computer), a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the functional block diagram of FIG. 1, device 10 may include components located on or within an electronic device housing such as housing 12. Housing 12, which may sometimes be referred to as a case, may be formed from plastic, glass, ceramics, fiber composites, metal (e.g., stainless steel, aluminum, metal alloys, etc.), other suitable materials, or a combination of these materials.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing wireless communications protocols (sometimes also referred to as communications protocols or communications standards). Communications protocols (standards) that may be implemented using control circuitry 14 include wireless local area network (WLAN) protocols (e.g., IEEE 802.11 protocols—sometimes referred to as Wi-Fi® such as a Wi-Fi 6 protocol, a Wi-Fi 7 protocol, or other Wi-Fi protocols), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), satellite navigation system protocols (e.g., global positioning system (GPS) protocols, global navigation satellite system (GLONASS) protocols, etc.), satellite communications (satcom) protocols, antenna-based spatial ranging protocols, optical communications protocols, or any other desired communications protocols. Each communications protocol may be associated with a corresponding radio access technology (RAT) that specifies the physical connection methodology used in implementing the protocol (e.g., used in transmitting and/or receiving radio-frequency signals under or according to the protocol).

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support or perform radio-frequency signal transmission and/or reception for device 10. Wireless circuitry 24 may be used for wireless communications. Wireless communications performed by wireless circuitry 24 may include or involve wireless data communications (e.g., where wireless data is carried by radio-frequency signals conveyed between wireless circuitry 24 and other communications equipment bidirectionally or unidirectionally), radio-frequency signal transmission, radio-frequency signal reception, and/or radio-based spatial ranging/sensing (e.g., radio detection and ranging (radar) operations, shorter range object detection such as near-field radio-frequency signal-based object detection, etc.). Radio-frequency signals conveyed by wireless circuitry 24 may include or carry wireless data (e.g., organized into frames, packets, symbols, datagrams, etc.), radar or other spatial ranging waveforms, continuous wave signals, chirp signals, control signals, management signals, reference signals, beacon signals, tones, pulses/impulses, waveforms associated with one or more communications protocols, and/or any other radio-frequency waveforms or signals. Wireless circuitry 24 is sometimes also referred to herein as wireless communications circuitry 24, wireless communication circuitry 24, communications circuitry 24, or simply as circuitry 24. Wireless circuitry 24 may include one or more antennas. Wireless circuitry 24 may also include baseband processor circuitry, transceiver circuitry, amplifier circuitry, filter circuitry, switching circuitry, radio-frequency transmission lines, and/or any other circuitry for transmitting and/or receiving radio-frequency signals using the antenna(s). Some or all of the components of wireless circuitry 24 may be disposed on, mounted to, and/or integrated within the same substrate (e.g., a printed circuit board, semiconductor substrate, chip, integrated circuit (IC), IC packages, etc.) or may be distributed between two or more substrates (e.g., printed circuit boards, semiconductor substrates, chips, ICs, IC packages, etc.).

Wireless circuitry 24 may transmit and/or receive radio-frequency signals within a corresponding frequency band at radio frequencies (sometimes referred to herein as a communications band or simply as a “band”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), a Wi-Fi® 7 band, and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, etc.), other centimeter or millimeter wave frequency bands between 10-100 GHz, sub-THz frequency bands between around 100 GHz and 10 THz (e.g., 6G bands), near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, satellite communications (satcom) bands (e.g., an IEEE C band (4-8 GHz), S band (2-4 GHz), L band (1-2 GHz), X band (8-12 GHz), W band (75-110 GHz), V band (40-75 GHz), K band (18-27 GHz), Kₐ band (26.5-40 GHz), Kᵤ band (12-18 GHz), etc.), unlicensed bands, communications bands under the family of 3GPP wireless communications standards, communications bands under the IEEE 802.XX family of standards, and/or any other desired frequency bands of interest. Different communications protocols may utilize different frequency bands for conveying radio-frequency signals. In some cases, two or more communications protocols may utilize one or more of the same frequency bands for conveying radio-frequency signals.

The example of FIG. 1 is illustrative and non-limiting. Although control circuitry 14 is shown separately from wireless circuitry 24 in the example of FIG. 1 for the sake of clarity, wireless circuitry 24 may include processing circuitry (e.g., one or more processors) that forms a part of processing circuitry 18 and/or storage circuitry that forms a part of storage circuitry 16 of control circuitry 14 (e.g., portions of control circuitry 14 may be implemented on wireless circuitry 24). As an example, control circuitry 14 may include baseband circuitry (e.g., one or more baseband processors) or other control circuitry that forms part of one or more radios in wireless circuitry 24. The baseband circuitry may, for example, access a communication protocol stack on control circuitry 14 (e.g., storage circuitry 20) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer. If desired, the PHY layer operations may additionally or alternatively be performed by radio-frequency (RF) interface circuitry in wireless circuitry 24.

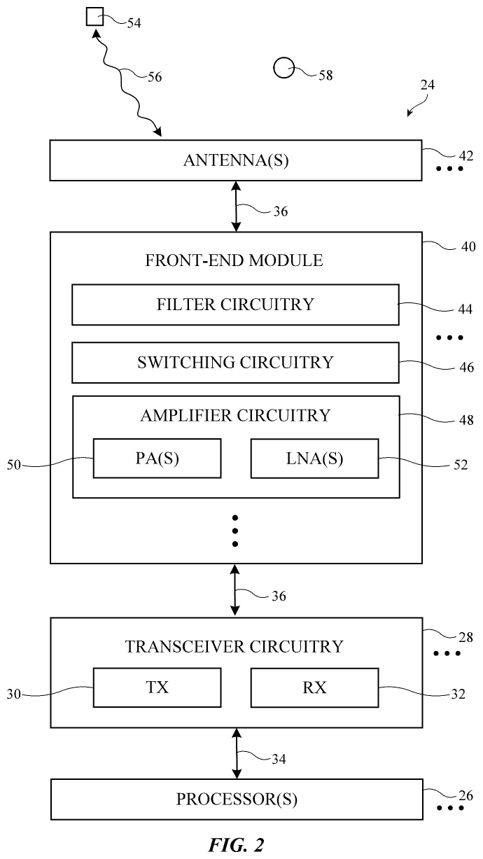

FIG. 2 is a diagram showing illustrative components within wireless circuitry 24. As shown in FIG. 2, wireless circuitry 24 may include a processor such as processor 26, radio-frequency (RF) transceiver circuitry such as transceiver circuitry 28, radio-frequency front end circuitry such as radio-frequency front end (RFFE) module 40 (sometimes also referred to herein as front end module (FEM) 40), and antenna(s) 42. Processor 26 may be a baseband processor, application processor, general purpose processor, microprocessor, microcontroller, digital signal processor, host processor, application specific signal processing hardware, or other type of processor. Processor 26 may be coupled to transceiver circuitry 28 over path 34. Transceiver circuitry 28 may be coupled to antenna 42 via radio-frequency transmission line path 36. Radio-frequency front end module 40 may be disposed on radio-frequency transmission line path 36 between transceiver circuitry 28 and antenna 42.

In the example of FIG. 2, wireless circuitry 24 is illustrated as including only a single processor 26, a single transceiver circuitry 28, a single front end module 40, and a single antenna 42 for the sake of clarity. In general, wireless circuitry 24 may include any desired number of processors 26, any desired number of transceiver circuitries 28, any desired number of front end modules 40, and any desired number of antennas 42. Each processor 26 may be coupled to one or more transceiver circuitries 28 over respective paths 34. Each transceiver circuitry 28 may include one or more transceivers. A transceiver in transceiver circuitry 28 may include a transmitter (TX) 30 configured to output uplink signals to antenna 42 and/or may include a receiver (RX) 32 configured to receive downlink signals from antenna 42. Each radio-frequency transmission line path 36 may have a respective front end module 40 disposed thereon. If desired, two or more front end modules 40 may be disposed on the same radio-frequency transmission line path 36. If desired, one or more of the radio-frequency transmission line paths 36 in wireless circuitry 24 may be implemented without any front end module disposed thereon.

Radio-frequency transmission line path 36 may be coupled to an antenna feed on antenna 42. The antenna feed may, for example, include a positive antenna feed terminal and a ground antenna feed terminal. Radio-frequency transmission line path 36 may have a positive transmission line signal path that is coupled to the positive antenna feed terminal on antenna 42. Radio-frequency transmission line path 36 may have a ground transmission line signal path that is coupled to the ground antenna feed terminal on antenna 42. This example is illustrative and, in general, antennas 42 may be fed using any desired antenna feeding scheme. If desired, antenna 42 may have multiple antenna feeds that are coupled to one or more radio-frequency transmission line paths 36.

Radio-frequency transmission line path 36 may include transmission lines that are used to route radio-frequency antenna signals within device 10 (FIG. 1). Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Transmission lines in device 10 such as transmission lines in radio-frequency transmission line path 36 may be integrated into rigid and/or flexible printed circuit boards.

While performing wireless transmission, processor 26 may provide transmit signals (e.g., digital or baseband signals) to transceiver circuitry 28 over path 34. Transceiver circuitry 28 may further include circuitry for converting the transmit (baseband) signals received from processor 26. For example, transceiver circuitry 28 may include mixer circuitry for up-converting (or modulating) the transmit (baseband) signals to radio frequencies prior to transmission over antenna 42. The example of FIG. 2 in which processor 26 communicates with transceiver circuitry 28 is illustrative. In general, transceiver circuitry 28 may communicate with a baseband processor, an application processor, general purpose processor, a microcontroller, a microprocessor, or one or more processors within circuitry 18. Transceiver circuitry 28 may also include digital-to-analog converter (DAC) and/or analog-to-digital converter (ADC) circuitry for converting signals between digital and analog domains. Transceiver circuitry 28 may use transmitter 30 to transmit the radio-frequency signals over antenna 42 via radio-frequency transmission line path 36 and front end module 40. Antenna 42 may transmit the radio-frequency signals to external wireless equipment by radiating the radio-frequency signals into free space.

While performing wireless reception, antenna 42 may receive radio-frequency signals from the external wireless equipment. The received radio-frequency signals may be conveyed to transceiver circuitry 28 via radio-frequency transmission line path 36 and front end module 40. Transceiver circuitry 28 may include circuitry such as receiver 32 for receiving signals from front end module 40 and for converting the received radio-frequency signals into corresponding baseband signals. For example, transceiver circuitry 28 may include mixer circuitry for down-converting (or demodulating) the received radio-frequency signals to baseband frequencies prior to conveying the received signals to processor 26 over path 34.

Front end module (FEM) 40 may include radio-frequency front end circuitry that operates on the radio-frequency signals conveyed (transmitted and/or received) over radio-frequency transmission line path 36. FEM 40 may, for example, include front end module (FEM) components such as radio-frequency filter circuitry 44 (e.g., low pass filters, high pass filters, notch filters, band pass filters, multiplexing circuitry, duplexer circuitry, diplexer circuitry, triplexer circuitry, etc.), switching circuitry 46 (e.g., one or more radio-frequency switches), radio-frequency amplifier circuitry 48 (e.g., one or more power amplifiers 50 and/or one or more low-noise amplifier circuits 52), signal attenuators, impedance matching circuitry (e.g., circuitry that helps to match the impedance of antenna 42 to the impedance of radio-frequency transmission line 36), antenna tuning circuitry (e.g., networks of capacitors, resistors, inductors, and/or switches that adjust the frequency response of antenna 42), radio-frequency coupler circuitry, charge pump circuitry, power management circuitry, digital control and interface circuitry, and/or any other desired circuitry that operates on the radio-frequency signals transmitted and/or received by antenna 42. Each of the front end module components may be mounted to a common (shared) substrate such as a rigid printed circuit board substrate or flexible printed circuit substrate. If desired, the various front end module components may also be integrated into a single integrated circuit chip. If desired, amplifier circuitry 48 and/or other components in FEM 40 such as filter circuitry 44 may also be implemented as part of transceiver circuitry 28.

Filter circuitry 44, switching circuitry 46, amplifier circuitry 48, and other circuitry may be disposed along radio-frequency transmission line path 36, may be incorporated into FEM 40, and/or may be incorporated into antenna 42 (e.g., to support antenna tuning, to support operation in desired frequency bands, etc.). These components, sometimes referred to herein as antenna tuning components, may be adjusted (e.g., using control circuitry 14) to tune the frequency response and wireless performance of antenna 42 over time.

Transceiver circuitry 28 may be separate from front end module 40. For example, transceiver circuitry 28 may be formed on another substrate such as the main logic board of device 10, a rigid printed circuit board, or flexible printed circuit that is not a part of front end module 40. As an example, processor 26 and/or portions of transceiver circuitry 28 (e.g., a host processor on transceiver 28) may form a part of control circuitry 14 of FIG. 1. Control circuitry 14 (e.g., portions of control circuitry 14 formed on processor 26, portions of control circuitry 14 formed on transceiver circuitry 28, and/or portions of control circuitry 14 that are separate from wireless circuitry 24) may provide control signals (e.g., over one or more control paths in device 10) that control the operation of front end module 40.

Transceiver circuitry 28 may include wireless local area network transceiver circuitry that handles WLAN communications bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network transceiver circuitry that handles the 2.4 GHz Bluetooth® band or other WPAN communications bands, cellular telephone transceiver circuitry that handles cellular telephone bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands above 100 GHz, etc.), near-field communications (NFC) transceiver circuitry that handles near-field communications bands (e.g., at 13.56 MHz), satellite navigation receiver circuitry that handles satellite navigation bands (e.g., a GPS band from 1565 to 1610 MHz, a Global Navigation Satellite System (GLONASS) band, a BeiDou Navigation Satellite System (BDS) band, etc.), ultra-wideband (UWB) transceiver circuitry that handles communications using the IEEE 802.15.4 protocol and/or other ultra-wideband or impulse-based communications protocols, and/or any other desired radio-frequency transceiver circuitry for covering any other desired communications bands of interest.

Wireless circuitry 24 may include one or more antennas such as antenna 42. Antenna 42 may be formed using any desired antenna structures. For example, antenna 42 may be an antenna with a resonating element that is formed from loop antenna structures, patch antenna structures, inverted-F antenna structures, slot antenna structures, planar inverted-F antenna structures, helical antenna structures, monopole antennas, dipoles, hybrids of these designs, etc. Two or more antennas 42 may be arranged into one or more phased antenna arrays (e.g., for conveying radio-frequency signals at millimeter wave frequencies). Parasitic elements may be included in antenna 42 to adjust antenna performance. Antenna 42 may be provided with a conductive cavity that backs the antenna resonating element of antenna 42 (e.g., antenna 42 may be a cavity-backed antenna such as a cavity-backed slot antenna).

The term “convey radio-frequency signals” as used herein means the transmission and/or reception of the radio-frequency signals (e.g., for performing unidirectional and/or bidirectional wireless communications with external wireless communications equipment). Antennas 42 may transmit the radio-frequency signals by radiating the radio-frequency signals into free space (or to free space through intervening device structures such as a dielectric cover layer). Antennas 42 may additionally or alternatively receive the radio-frequency signals from free space (e.g., through intervening devices structures such as a dielectric cover layer). The transmission and reception of radio-frequency signals by antennas 42 each involve the excitation or resonance of antenna currents on an antenna resonating element in the antenna by the radio-frequency signals within the frequency band(s) of operation of the antenna.

In some implementations, wireless circuitry 24 may convey radio-frequency signals 56 with external equipment such as external communications equipment 54. External communications equipment 54 may include one or more other devices such as device 10 (e.g., a user equipment (UE) device), one or more wireless access points (APs), one or more wireless base stations (e.g., gNBs), and/or any other desired equipment that wirelessly transmits and/or receives radio-frequency signals 56. Radio-frequency signals 56 may, if desired, carry wireless communications data between wireless circuitry 24 and external communications equipment 54 (e.g., packets, symbols, frames, datagrams, data encoded in a series of impulses, etc.). Wireless communications data (sometimes also referred to simply as wireless data or data) may be conveyed bidirectionally or unidirectionally (e.g., in an uplink (UL) direction from wireless circuitry 42 to external communications equipment 54 and/or in a downlink (DL) direction from external communications equipment 54 to wireless circuitry 42). The wireless communications data may, for example, include wireless data associated with a telephone call, streaming media content, internet browsing, wireless data associated with software applications running on device 10, email messages, etc.

In addition to, or instead of, conveying wireless communications data with external communications equipment 54, wireless circuitry 24 may use antennas 42 to perform radio-frequency sensing operations (sometimes referred to herein as radio-based sensing, spatial ranging, radio detection and ranging (radar), object detection, or simply as sensing). The sensing operations may allow device 10 to detect (e.g., sense or identify) the presence, location, orientation, and/or velocity (motion) of objects external to device 10 such as external object 58. Detecting, sensing, or identifying the presence, location, orientation, and/or velocity (motion) of external object 58 at any given time or over a given time period is sometimes also referred to herein as object detection operations, detecting the external object or performing spatial ranging operations, ranging operations, radio-based sensing operations, or range detection. Wireless circuitry 24 may perform sensing operations over a relatively short range such as ranges of a few cm from antennas 42 or over longer ranges such as ranges of dozens of cm, a few meters, dozens of meters, etc. External objects such as external object 58 may still be present around, nearby, adjacent to, overlapping, on top of, in contact with, and/or within a line of sight of device 10 and may still affect the operations of wireless circuitry 24 even when wireless circuitry 24 does not use antennas 42 to perform radio-frequency sensing operations on external object 58 or other objects.

External object 58 may be, for example, the ground, a building, part of a building, a wall, furniture, a ceiling, a person, a body part (e.g., the head, hand, finger, or other body part of the user of device 10 or other humans in the vicinity of device 10), an animal, a vehicle, a landscape or geographic feature, an obstacle, external communications equipment, another device of the same type as device 10 or a peripheral/accessory device such as a gaming controller, stylus (e.g., for providing input to a touch and/or force-sensitive display on device 10), or remote control, or any other physical object or entity that is external to device 10. External object 58 may be a living, animate, and/or moving object or may be a non-living inanimate, stationary, and/or non-living object.

During radio-frequency signal transmission, some of the radio-frequency signals transmitted by antenna(s) 42 may be incident upon external objects such as external object 58. In these scenarios, the amount of radio-frequency energy exposure at external object 58 may be characterized by one or more radio-frequency (RF) energy exposure metrics. The RF exposure (RFE) metrics may include specific absorption rate (SAR) (e.g., for radio-frequency signals at frequencies less than 6 GHz (in units of W/kg)), maximum permissible exposure (MPE) (e.g., for radio-frequency signals at frequencies greater than 6 GHz (in units of mW/cm²)), and total exposure ratio (TER), which combines SAR and MPE. As used herein, the RFE of wireless circuitry 24 may be defined as the SAR, MPE, TER, and/or any other radio-frequency energy exposure metric of wireless circuitry 24.

Regulatory requirements often impose limits on the amount of RFE permissible for external objects 58 (e.g., the human body, a body part, animals, etc.) within the vicinity of antenna(s) 42 over a specified time period (e.g., an SAR limit and an MPE limit over a corresponding regulatory averaging period). A regulatory body governing a geographic area where device 10 is located may impose, for example, a SAR limit of 1.6 W/kg over a corresponding regulatory averaging period. Each radio in wireless circuitry 24 that is subject to a SAR limit may need to share an overall RFE budget for wireless circuitry 24 such that the radios collectively meet this SAR limit over the averaging period. Each radio may transmit signals according to a different respective RFE budget and all of the respective RFE budgets may collectively form the overall RFE budget for wireless circuitry 24. Wireless circuitry 24 may include an RFE manager for ensuring that radios in wireless circuitry 24 comply with these regulatory requirements (e.g., implemented as a part of transceiver circuitry 28, control circuitry 14 or processing circuitry 18 of FIG. 1, using Layer 1 circuitry and/or circuitry that operates at higher layers, etc.). External objects 58 may be living objects (e.g., objects made of organic and/or RF absorbing material that may perform at least some amount of motion such as micro-movements even when the objects are otherwise stationary or still) or may be non-living objects. Some types of external objects (e.g., objects made of organic material, living objects, etc.) may absorb more RF energy and may thereby cause a transmitting antenna to consume more SAR/MPE than other types of external objects of the same geometry and distance (e.g., objects made of non-organic material, non-living objects, etc.).

Device 10 may detect the presence and/or effect of external objects 58 at, adjacent, overlapping, or near antennas 42 using any desired combination of one or more sensors in device 10 (e.g., sensors in input-output devices 22 of FIG. 1). When an external object 58 is located at, adjacent, overlapping, or near an antenna 42, and/or when the external object loads the impedance of antenna 42 by at least a threshold amount (e.g., shifting the impedance of the antenna away from a nominal impedance), that antenna is sometimes also referred to herein as being occluded by the external object (e.g., the external object occludes the antenna from being able to freely convey radio-frequency signals to freespace without at least some of the signals being blocked, exposed to, and/or absorbed by the external object). When no external objects 58 that exhibit similar absorptive characteristics as organic tissue are located at, adjacent, overlapping, or near an antenna 42, when no external objects 58 block antenna 42 by at least a threshold amount, and/or when no external objects 58 load the impedance of antenna 42 by at least a threshold amount (e.g., when the antenna 42 remains substantially at a nominal impedance), that antenna is sometimes also referred to herein as being non-occluded or in a free space environment. Antenna 42 may, for example, still be referred to herein as operating in a free space (non-occluded) environment or state in the presence of non-metallic external objects that do not exhibit similar RF absorption characteristics as organic tissue (e.g., that do not exhibit a similar risk of violation of regulatory limits on RFE as a living external object), such as a non-metallic removable device case or cover.

The sensor(s) in device 10 may, for example, detect whether or not a given antenna 42 is operating in an occluded state or a non-occluded state. Device 10 may use these detections to ensure that device 10 continues to comply with regulatory requirements on RFE, particularly when living external objects 58 are nearby. Device 10 may, for example, use these detections to adjust the operation of one or more antennas 42 to ensure compliance with the regulatory requirements given the present location or characteristics of external object 58 (e.g., by adjusting the transmit power level, maximum transmit power level, or maximum transmit power backoff (PBO) level of antennas 42, by switching an occluded antenna 42 out of use, by switching a non-occluded antenna 42 into use, etc.). The sensor(s) may, for example, generate sensor data indicative of the presence and/or effect of external object 58 at, adjacent, overlapping, or near antennas 42.

In implementations that are described herein as an example, the sensor(s) may include radio-frequency sensors coupled to corresponding antennas 42. The radio-frequency sensors may include antenna impedance sensors that perform impedance measurements of antennas 42 to detect whether antennas 42 are occluded by animate external objects 58. The impedance measurements may include complex scattering parameter measurements (e.g., S-parameter measurements) for the antennas. In some implementations that are described herein as an example, the antenna impedance sensors may include voltage standing wave ratio (VSWR) sensors that perform VSWR measurements of antennas 42 to detect whether antennas 42 are occluded by animate external objects 58 (e.g., the impedance measurements may include VSWR values of antennas 42). Each VSWR sensor may include a corresponding signal coupler (e.g., a radio-frequency switch coupler such as a four-port switch coupler) and receiver circuitry such as one or more power detectors and/or feedback receivers that are communicatively coupled to a corresponding signal coupler for measuring the VSWR of the antenna 42 coupled to the signal coupler. Device 10 may use the VSWR measurements to detect whether the corresponding antenna 42 is occluded or in a free space environment. The VSWR sensor may, for example, be used to detect when an antenna 42 has transitioned from being occluded to being non-occluded (e.g., whether antenna 42 has entered a free space environment) and is sometimes also referred to herein as a free space sensor for that antenna 42. This example is illustrative and non-limiting. If desired, the VSWR sensors described herein may be replaced with any desired radio-frequency sensors or antenna impedance sensors and the VSWR measurements described herein may be replaced with any desired antenna impedance measurements.

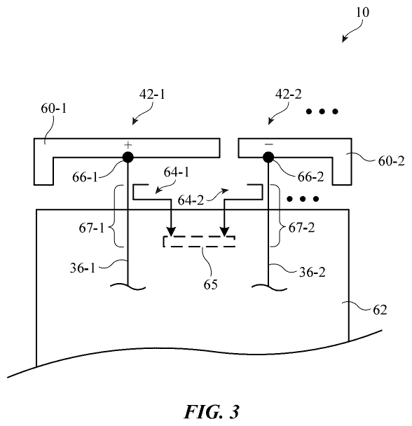

In practice, wireless circuitry 24 may include a set of M antennas 42 that are communicatively coupled to corresponding VSWR sensors for detecting whether the antennas are being occluded (e.g., where M is an integer greater than or equal to one). The set of M antennas 42 may be disposed at one or more locations on or in device 10. FIG. 3 is a cross-sectional front view illustrating one example in which device 10 includes at least two antennas 42 at an upper end of a housing for device 10 (e.g., in implementations where device 10 is a portable electronic device having a substantially rectangular form factor, such as implementations where device 10 is a cellular telephone or tablet computer).

As shown in FIG. 3, device 10 may include one or more antennas 42 such as at least antenna 42-1 and antenna 42-2. Antennas 42-1 and 42-2 may have antenna resonating elements (e.g., antenna resonating element arms) formed from respective segments 60 of a conductive housing for device 10. For example, antenna 42-1 may have an antenna resonating element formed from a first segments 60-1 and antenna 42-2 may have an antenna resonating element formed from a second segment 60-2 of a conductive housing for device 10. Segments 60-1 and 60-2 may, for example, be formed from peripheral conductive housing structures that extend around some or all of the lateral periphery of device 10 (e.g., conductive sidewalls or a conductive bezel of device 10). If desired, device 10 may include a display (not shown) mounted to the peripheral conductive housing structures.

Segment 60-1 may be separated from segment 60-2 by a dielectric-filled gap in the conductive housing (e.g., the dielectric-filled gap may divide the peripheral conductive housing structures into segments 60-1 and 60-2). Segments 60-1 and 60-2 may be separated from a ground plane 62 for antennas 40-1 and 40-2 by a dielectric-filled slot. Ground plane 62 may include a conductive housing wall of device 10 (e.g., a conductive rear housing wall opposite a display of device 10), a conductive support plate or chassis for device 10, conductive structures of one or more components within device 10, conductive traces on one or more substrates within device 10, and/or any other desired conductive structures held at a ground or reference potential, as examples.

Each antenna 42 may be fed, at a corresponding antenna feed 66, by a respective radio-frequency transmission line path 36. The antenna feed of each antenna may be coupled between the antenna resonating element and the ground plane for the antenna. For example, antenna 42-1 may be fed by at least one antenna feed 66-1 coupled to segment 60-1 (e.g., at a positive antenna feed terminal for antenna 42-1) and antenna 42-2 may be fed by at least one antenna feed 66-2 coupled to segment 60-2 (e.g., at a positive antenna feed terminal for antenna 42-2). A first radio-frequency transmission line path 36-1 may be coupled to antenna feed 66-1 and may carry radio-frequency signals between transceiver circuitry 28 (FIG. 2) and antenna 42-1. A second radio-frequency transmission line path 36-2 may be coupled to antenna feed 66-2 and may carry radio-frequency signals between transceiver circuitry 28 (FIG. 2) and antenna 42-2.

One or more of the antennas 42 in device 10 may be coupled to a corresponding VSWR sensor 67. Each VSWR sensor 67 may include a corresponding radio-frequency signal coupler 64 (e.g., a bi-directional switch coupler) coupled to the radio-frequency transmission line path 36 that feeds the associated antenna 42. Radio-frequency signal couplers 64 may have at least one terminal (node) that is communicatively coupled to receiver circuitry 65 of the VSWR sensor. Receiver circuitry 65 may include one or more power detectors, voltage detectors, current detectors, and/or feedback receivers, as examples. One or more terminals (nodes) of each radio-frequency signal coupler may be coupled to one or more fixed or adjustable impedance terminations. Each radio-frequency signal coupler may include switching circuitry. The radio-frequency signal coupler may couple radio-frequency energy (e.g., at least some of the radio-frequency signal power) propagating along its coupled radio-frequency transmission line path 36 and may pass the coupled radio-frequency energy to receiver circuitry 65. The switching circuitry may be adjusted to configure the radio-frequency signal coupler to couple either a forward signal wave propagating along the radio-frequency transmission line path towards the antenna feed, or a reverse (e.g., reflected) signal wave propagating along the radio-frequency transmission line path away from the antenna feed, to receiver circuitry 65.

Receiver circuitry 65 may measure the coupled signals in one or both directions to generate, calculate, produce, output, or otherwise identify one or more impedance measurements of its antenna 42. For example, receiver circuitry 65 may measure, sense, generate, or otherwise identify one or more complex scattering parameters (e.g., one or more of sixteen different possible S-parameters in implementations where the radio-frequency signal coupler is a four port coupler) and/or the VSWR of the antenna. Receiver circuitry 65 and/or processing circuitry in device 10 may process the VSWR measurements or other impedance-related measurements to identify the impedance loading conditions of the antenna, which are affected by and characteristic of the presence or absence of external objects 58 at, near, adjacent, and/or overlapping the antenna. The VSWR measurements for a given antenna may vary, for example, depending on the frequency of the transmitted signals, the dimensions/geometry of the external object, the angle of the external object relative to the antenna, properties of the materials in the external object, a distance between the external object and the antenna, an amount of overlap between the external object and the antenna, etc. The processing circuitry may use the VSWR measurements from a given antenna 42 to determine whether the antenna is in an occluded state or a free space state.

In the example of FIG. 3, device 10 includes a first VSWR sensor 67-1 coupled to antenna 42-1 for measuring the VSWR of antenna 42-1 (e.g., for detecting whether antenna 42-1 is occluded or not occluded) and includes a second VSWR sensor 67-2 coupled to antenna 42-2 for measuring the VSWR of antenna 42-2 (e.g., for detecting whether antenna 42-2 is occluded or not occluded). First VSWR sensor 67-1 may include a radio-frequency signal coupler 64-1 coupled to radio-frequency transmission line path 36-1. Radio-frequency signal coupler 64-1 may be coupled to corresponding receiver circuitry 65 that is associated with or included in the first VSWR sensor (e.g., for measuring the VSWR of antenna 42-1 based on radio-frequency signals coupled off of radio-frequency transmission line path 36-1 by radio-frequency signal coupler 64-1). Second VSWR sensor 67-2 may include a radio-frequency signal coupler 64-2 coupled to radio-frequency transmission line path 36-2. Radio-frequency signal coupler 64-2 may be coupled to corresponding receiver circuitry 56 that is associated with or included in the second VSWR sensor (e.g., for measuring the VSWR of antenna 42-2 based on radio-frequency signals coupled off of radio-frequency transmission line path 36-2 by radio-frequency signal coupler 64-2). VSWR sensors 67-1 and 67-2 may include the same (shared) receiver circuitry 65 or may each include different respective receiver circuitries 65.

The example of FIG. 3 is illustrative and non-limiting. If desired, device 10 may include one or more antennas 42 that only receive signals (e.g., receive antennas). These antennas may be implemented without a corresponding VSWR sensor if desired. Device 10 may include more than two antennas 42 at its upper end or may include just a single antenna 42 at its upper end. More generally, device 10 may include any desired number of antennas 42, and a set of one or more of those antennas 42 may be provided with a corresponding VSWR sensor 67 for measuring the VSWR of that antenna (e.g., to detect whether the antenna is occluded). Device 10 may have any desired form factor and the antenna(s) may be disposed or integrated within device 10 in any desired manner.

In practice, a given antenna 42 in wireless circuitry 24 may be operable in at least two RFE states for ensuring compliance with regulatory requirements on RFE (e.g., an occluded state and a free space state). Each RFE state may be associated with a different respective range of VSWR measurements (e.g., a different amount of loading by an external object 58) and a different respective maximum transmit power level constraint (e.g., a different respective maximum transmit power level backoff) that is used to ensure that the antenna continues to comply with regulatory requirements on RFE given the presence or absence of external objects 58. In some implementations that are described herein as an example, an antenna 42 may be operable in two different occluded states, sometimes also referred to herein as a body state and an extremity state.

FIG. 3 is a state diagram showing how a given antenna 40 may operate in and transition between at least three different RFE states (modes or conditions): a free space (non-occluded) state 70 and two occluded states such as extremity state 68 and body state 72. Extremity state 68 is sometimes also referred to herein as extremity mode 68 or extremity condition 68. Body state 72 is sometimes also referred to herein as body mode 72 or body condition 72. Free space state 70 is sometimes also referred to herein as free space mode 70 or free space condition 70.

Antenna 42 may be in free space state 70 when the VSWR measurements gathered from the antenna are within a first range of VSWR values (e.g., a range of VSWR values associated with antenna 42 operating in free space, in the absence of animate external objects 58). The first range of VSWR values is sometimes also referred to herein as a free space set, free space cluster, free space reference set, free space reference cluster, reference set, or reference cluster of VSWR values or measurements. While in free space state 70, there is no risk that radio-frequency transmission by antenna 42 will produce an amount of RFE on an external object 58 that would cause the antenna to violate a regulatory requirement or limit on RFE. As such, antenna 42 may transmit radio-frequency signals with a highest possible maximum transmit power level while in free space state 70 (e.g., at transmit powers that are capped only by the highest maximum power level supported by the transmit chain feeding the antenna). This is sometimes also referred to herein as transmitting radio-frequency signals without a maximum transmit power level constraint or without a maximum transmit power level backoff (e.g., wireless circuitry 24 need not cap, reduce, or limit the maximum transmit power level of antenna 42 while ensuring compliance with regulatory RFE limits while operating in free space).

While in an occluded state, there is at least some risk that, if care is not taken (e.g., if a maximum transmit power level constraint is not imposed), radio-frequency transmission by antenna 42 will produce an amount of RFE on an external object 58 that would cause the antenna to exceed a regulatory requirement or limit on RFE. For example, there may be more risk of regulatory RFE limit violation if/when antenna 42 is in extremity state 68 than if/when antenna 42 is in free space state 70, and there may be more risk of regulatory RFE limit violation if/when antenna 42 is in body state 72 than if/when antenna 42 is in extremity state 68. Antenna 42 may be in extremity state 68, for example, when the VSWR measurements gathered from the antenna are within a second range of VSWR values different from the first range of VSWR values (e.g., where the second range of VSWR values is associated with or corresponds to antenna 42 operating in an environment where the antenna is being held in a user's hand, is located on the user's wrist or ankle, or is otherwise located on an extremity or limb of a living external object, an environment where the antenna(s) in device 10 are located near to but not in contact with or close to a body extremity, etc.). On the other hand, antenna 42 may be in body state 72, for example, when the VSWR measurements gathered from the antenna are within a third range of VSWR values different from the first and second ranges of VSWR values (e.g., where the third range of VSWR values is associated with or corresponds to antenna 42 being located on a part of a user's body other than an extremity, being located on or near a user's head or ear, being located in an environment where the antenna(s) in device 10 are very close to or in contact with the user's body, etc.). In practice, under a constant transmit power level and frequency over a fixed time period, while loaded by the same external object 58 at the same distance, antenna 42 may produce higher RFE while in body state 72 than while in extremity state 68. As such, if care is not taken, the antenna may be at higher risk of RFE violation while in body state 72 than while in extremity state 68. The second and third ranges of VSWR values are sometimes also referred to herein as occluded sets or occluded clusters of VSWR values.

To help mitigate the risk of RFE violation, while in extremity state 68, antenna 42 may transmit radio-frequency signals with a first reduced (limited) maximum transmit power level that is lower than the highest possible maximum transmit power level of the antenna (e.g., antenna 42 may transmit radio-frequency signals at transmit power levels that are capped or limited by a lower maximum transmit power level than the highest maximum transmit power level supported by the transmit chain feeding the antenna). Put differently, antenna 42 may transmit radio-frequency signals using a first (e.g., relatively low) amount of maximum transmit power level backoff while in extremity state 68. This is sometimes also referred to herein as transmitting radio-frequency signals with a first (less strict) maximum transmit power level constraint (e.g., where wireless circuitry 24 caps, reduces, or limits the maximum transmit power level of antenna 42 by a relatively low amount to help ensure compliance with regulatory RFE limits, given the presence of an external object 58, without excessively degrading transmit performance).

Similarly, while in body state 72, antenna 42 may transmit radio-frequency signals with a second reduced maximum transmit power level that is lower than the first reduced maximum transmit power level (e.g., antenna 42 may transmit radio-frequency signals at transmit powers that are capped or limited by an even lower maximum transmit power level than the first reduced maximum transmit power level of the antenna). Put differently, antenna 42 may transmit radio-frequency signals using a second (e.g., relatively high) amount of maximum transmit power level backoff. This is sometimes also referred to herein as transmitting radio-frequency signals with a second (stricter) maximum transmit power level constraint (e.g., where wireless circuitry 24 caps, reduces, or limits the maximum transmit power level of antenna 42 by a relatively high or maximum amount to help ensure compliance with regulatory RFE limits, given the close presence of an external object 58, regardless of degradation to transmit performance).

The VSWR sensor 67 of antenna 42 may be used to identify whether the antenna is in one of states 70, 72, or 68 at any given time. For example, the VSWR sensor 67 coupled to antenna 42 may perform one or more VSWR measurements using radio-frequency signals transmitted by the antenna. Processing circuitry 18 (FIG. 1) may then use the VSWR measurements performed by the VSWR sensor to detect whether antenna 42 is in free space state 70, extremity state 68, or body state 72. The processing circuitry may then adjust the maximum transmit power level or the maximum transmit power level backoff of the antenna based on the detected state (e.g., using no maximum transmit power level backoff when antenna 42 is detected to be in free space 70, a first maximum transmit power level backoff when antenna 42 is detected to be in extremity state 68, and a second maximum transmit power level backoff greater than the first maximum transmit power level backoff when antenna 42 is detected to be in body state 72). This may help to optimize or balance radio-frequency signal transmission performance with maintaining regulatory RFE limit compliance given the current environmental/loading conditions of the antenna (e.g., as characterized by the VSWR measurements).

The processing circuitry may also use the VSWR measurements to detect when the antenna has transitioned from one RFE state to another RFE state. For example, the processing circuitry may use the VSWR measurements to detect, identify, or determine if/when the antenna has transitioned from an occluded state (e.g., extremity state 68 or body state 72) to free space state 70. The processing circuitry may use this detection to identify when constraints on the maximum transmit power level of the antenna can be removed (e.g., increasing radio-frequency signal transmission performance) without risking violation of regulatory RFE limits. Put differently, the processing circuitry may decrease or remove the maximum transmit power level backoff applied to the antenna or may increase (e.g., maximize) the maximum transmit power level of the antenna in response to detecting that antenna 42 has moved from the occluded state to free space state 70. When operated to detect a transition from an occluded state to free space state 70 in this way, VSWR sensor 67 is sometimes also referred to herein as a free space sensor or free space detector for the antenna.

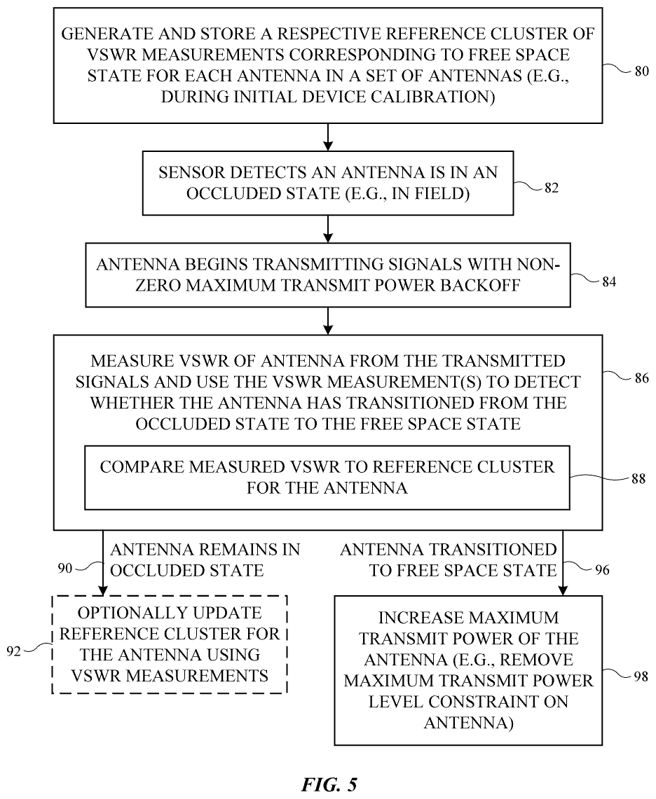

FIG. 5 is a flow chart of illustrative operations involved in operating wireless circuitry 24 to transmit signals and to perform free space sensing on a set of M antennas 42. At operation 80, wireless circuitry 24 may generate and store an initial reference cluster (set) of VSWR measurements corresponding to free space state 70 for each antenna 42 in the set of M antennas 42. This may occur, for example, during an initial calibration of wireless circuitry 24 and/or device 10.

For example, wireless circuitry 24 may be calibrated in a calibration system or in-factory during the assembly, manufacture, testing, and/or calibration of wireless circuitry 24 and/or device 10 (e.g., prior to device 10 being provided to an end user for in-field or real world use). During the calibration, each antenna 42 may be placed in a controlled/known free space environment (e.g., an anechoic chamber without external objects 58) and may transmit signals while VSWR measurements are performed for the antenna using its VSWR sensor 67. Some or all of these VSWR measurements may be stored as a reference cluster of VSWR measurements for the antenna (e.g., a free space reference cluster of VSWR measurements for the antenna). In this way, the reference cluster of VSWR measurements may be indicative of the VSWR characteristics of antenna 42 when operating in free space. The reference cluster of VSWR measurements for an antenna 42 that is identified during factory calibration of wireless circuitry 24 (e.g., at operation 80) is sometimes also referred to herein as the initial reference cluster, the factory cluster, or the factory reference cluster of VSWR measurements for the antenna. The factory cluster of VSWR measurements may form an initial (calibrated) reference cluster associated with antenna 42 operating in free space. If desired, wireless circuitry 24 may update the reference cluster of VSWR measurements over time (e.g., changing the reference cluster of VSWR measurements for the antenna to more accurately reflect the real-world operation of the antenna while non-occluded by external objects with sufficient absorptive characteristics to risk violating RFE limits). If desired, each antenna 42 that is provided with a VSWR sensor 67 in wireless circuitry 24 (e.g., each transmit antenna) may have its own respective reference cluster. The reference cluster(s) may be stored in storage circuitry for later use during in-field (real world) operation of device 10.

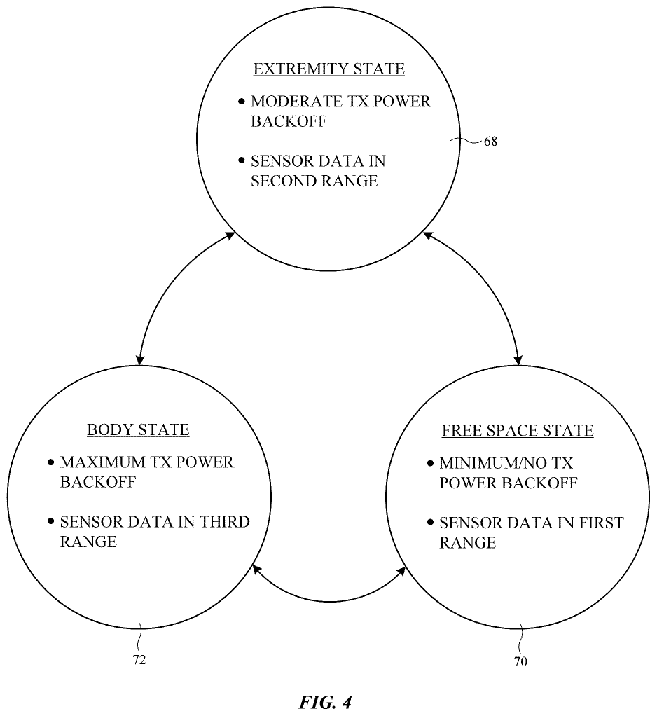

After wireless circuitry 24 and/or device 10 has been provided to an end user or is otherwise placed in a real world (in-field) condition outside of the factory or calibration system, processing may proceed to operation 82. At operation 82, one or more sensors in device 10 may detect when an antenna 42 in wireless circuitry 24 is in an occluded state (e.g., extremity state 68 or body state 72 of FIG. 4). The sensor(s) may include the VSWR sensor 67 of the antenna, a camera, a light sensor, an orientation sensor, a capacitive proximity sensor or another type of proximity sensor, a radar sensor, an acoustic (e.g., ultrasonic sensor), a light detection and ranging sensor, and/or any other sensors that may determine if/when an external object 58 is occluding the antenna. The remaining operations of FIG. 5 may be processed to determine if/when the antenna has transitioned from the occluded state to free state 70 (e.g., may be processed to perform free state detection for the antenna).

At operation 84, the transmitter (e.g., transmit chain) coupled to antenna 42 may begin to transmit radio-frequency signals using antenna 42. The transmitter and antenna 42 may continue to transmit radio-frequency signals concurrent with, before, and/or after one or more of the remaining operations of FIG. 5. Because antenna 42 is in an occluded state at this time, antenna 42 may transmit radio-frequency signals at a transmit power level that is less than or equal to (e.g., that is capped or limited by) a maximum transmit power level that is lower than the highest maximum transmit power level supported by the antenna (e.g., that is lower than the maximum transmit power level of the antenna while operated in free space state 70). Put differently, antenna 42 may transmit the radio-frequency signals with a non-zero maximum transmit power level backoff (e.g., while imposing a non-zero maximum transmit power level constraint). Maximum transmit power level backoff is sometimes also referred to herein as maximum transmit power backoff or simply as transmit power backoff. This may help antenna 42 to continue to comply with regulatory limits on RFE while in the occluded state.

At operation 86, the VSWR sensor 67 coupled to antenna 42 may perform a set of one or more VSWR measurements from the transmitted signals. Processing circuitry 18 (FIG. 1) may use the VSWR measurement(s) (sometimes also referred to herein as VSWR values, VSWR data, VSWR sensor data, or VSWR sensor values) to detect whether antenna 42 has transitioned from the occluded state into free space state 70. For example, at operation 88, processing circuitry 18 may compare the VSWR measurement(s) to the reference cluster for that antenna 42 (e.g., a factory reference cluster as generated during earlier processing of operation 80 or an updated reference cluster for the antenna as generated in-field during a previous iteration of the free space detection operations of FIG. 5).

This comparison may include, for example, comparing an elliptical distance of the VSWR measurement from the reference cluster for the antenna (e.g., from a center of the reference cluster) to a threshold value. If/when the elliptical distance exceeds a threshold, this means that that the VSWR measurement is excessively different (far) from the reference cluster (e.g., differs excessively from the expected VSWR characteristics of the antenna while operating in free space state 70), and processing circuitry 18 may determine, detect, decide, or identify that the antenna remains in an occluded state. On the other hand, if/when the elliptical distance is less than the threshold, this means that the VSWR measurements are sufficiently similar to the reference cluster (e.g., is sufficiently close to the expected VSWER characteristics of the antenna while operating in free space state 70), and processing circuitry 18 may determine, detect, decide, or identify that the antenna has transitioned to free space state 70 (e.g., processing circuitry 18 may output a free space detection signal that indicates or identifies that the antenna has transitioned to free space state 70).

If/when processing circuitry 18 detects that antenna 42 has entered free space state 70, processing may proceed from operation 86 to operation 98 via path 96. At operation 98 (e.g., responsive to detecting that antenna 42 has entered free space state 70), processing circuitry 18 may increase the maximum transmit power level of antenna 42 (e.g., to the highest maximum transmit power level supported by the antenna). Put differently, processing circuitry 18 may remove or decrease the maximum transmit power level backoff (e.g., the maximum transmit power level constraint) that was imposed on antenna 42 while the antenna operated in the occluded state. Antenna 40 may then continue to transmit the radio-frequency signals at transmit power levels less than or equal to the highest maximum transmit power level supported by the antenna. This may help to increase the wireless signal transmission performance of the antenna without risk of violating regulatory requirements on RFE (e.g., because antenna 42 is in the free space state).

On the other hand, if/when processing circuitry 18 detects that antenna 42 remains in the occluded state, antenna 42 may continue to transmit the radio-frequency signals using its current maximum transmit power level (e.g., its current maximum transmit power level backoff). If desired, the processing circuitry may further reduce the maximum transmit power level of the antenna (e.g., may further increase the maximum transmit power level backoff of the antenna) if/when processing circuitry 18 detects that antenna 42 has changed from extremity state 68 to body state 72.

If desired, if/when processing circuitry 18 detects that antenna 42 remains in (or returns to) the occluded state, processing may proceed from operation 86 to optional operation 92. Operation 92 may be omitted if desired. For example, if/when processing circuitry 18 detects that antenna 42 remains in or returns to the occluded state (e.g., from the free space state) an excessive number of times (e.g., with greater than a threshold frequency over a corresponding time period), processing may proceed from operation 86 to optional operation 92. This condition may occur when the impedance loading conditions previously considered to be a free space condition for antenna 42 has changed sufficiently for the antenna (e.g., indicating that the VSWR measurements of the reference cluster for the antenna is no longer reliably indicative of the antenna operating in the absence of animate external objects 58 that are subject to RFE requirements). This may occur, for example, when a user has placed a non-metallic (e.g., removable) device case or cover (or another non-metallic external object that exhibits less RF absorption than living tissue) onto device 10 or when the user has changed or swapped out non-metallic (e.g., removable) device cases on device 10. In these situations, different non-metallic (removable) device cases/covers will load the impedance of antenna 42 by different amounts (e.g., depending on the geometry and material of the removable device case or other inanimate external object). This may cause a shift in the VSWR measurements gathered from the antenna while operating in the absence of other external objects 58. Because non-metallic removable device cases are not as absorptive to RF energy as living tissue, they do not present a risk of violating regulatory RFE requirements/limits and/or may not be subject to regulatory RFE requirements/limits. When this occurs, this may be indicative of processing circuitry 18 needing to update its reference cluster for antenna 42 to more accurately reflect the current free space state of the antenna. The processing circuitry may then use the updated reference cluster for comparison to later VSWR measurements while performing free space detection at operation 88 (e.g., to know when maximum transmit power level constraints for the antenna can be removed to increase performance without risk of violating regulatory limits on RFE).

As such, when optional operation 92 is performed, processing circuitry 18 may update the reference cluster of VSWR measurements based on one or more VSWR measurements gathered while processing operation 86. This may serve to re-define what the processing circuitry considers to be a VSWR measurement characteristic of the antenna operating in free space state 70 in the absence of external objects 58 (e.g., based on the current loading of the antenna by a different non-metallic external object that is less absorptive to RF energy than living tissue, such as a non-metallic removable device case/cover), allowing the processing circuitry to more accurately perform free space detection for the antenna during subsequent VSWR measurements despite the change in non-metallic removable device case/cover over the antenna (e.g., allowing the processing circuitry to remove maximum transmit power level backoff for the antenna, thereby increasing transmit performance, without risk of regulatory RFE limit violation).

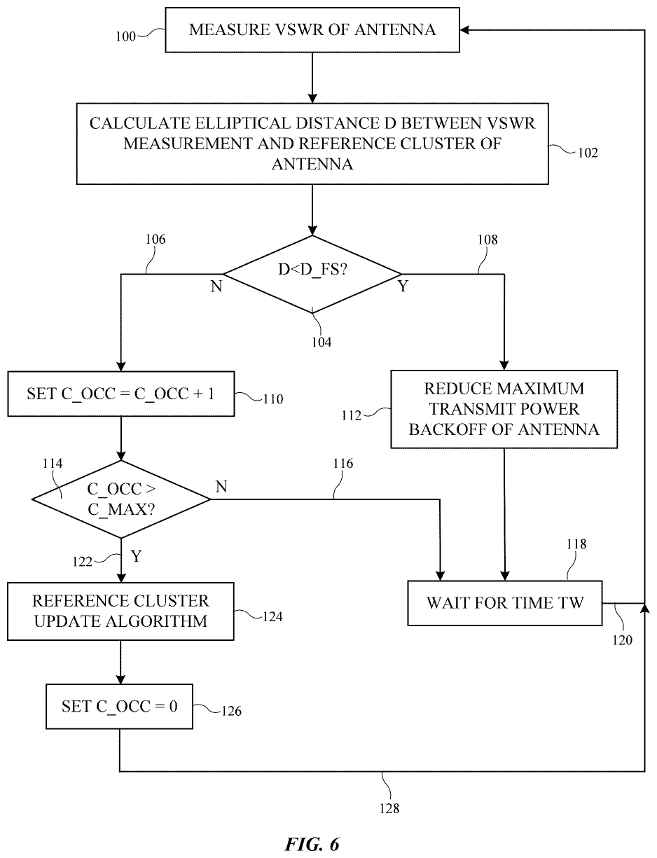

FIG. 6 is a flow chart of illustrative operations that may be performed to detect when antenna 42 has transitioned from an occluded state into free space state 70. The operations of FIG. 6 may be performed, for example while processing at least operation 86 of FIG. 5. Operations 100, 102, 104, 110, 114, and 118 of FIG. 6 may, for example, be performed while processing operations 86 and/or 88 of FIG. 5. Operation 112 of FIG. 6 may, for example, be performed while processing operation 98 of FIG. 5. Operations 124 and 126 of FIG. 6 may, for example, be performed while processing operation 92 of FIG. 5.

At operation 100 of FIG. 6, the VSWR sensor 67 of antenna 42 may measure the VSWR of antenna 42 while the antenna transmits radio-frequency signals (e.g., may gather, generate, sense, produce, calculate, and/or otherwise identify a corresponding VSWR measurement or value that characterizes, indicates, or identifies the measured VSWR of antenna 42). Processing circuitry 18 may store the VSWR measurement in storage circuitry for subsequent processing. The transmitted radio-frequency signals may be scheduled transmissions (e.g., as dictated by and transmitted in accordance with a network-generated communications schedule for device 10), scheduled or unscheduled spatial ranging signal transmissions, and/or dedicated (e.g., unscheduled) signal transmissions that are used for measuring VSWR.

At operation 102, processing circuitry 18 may calculate an elliptical distance D between the VSWR measurement and the current reference cluster for antenna 42 (e.g., the factory reference cluster for antenna 42 during a first iteration of FIG. 6 or an updated reference cluster for antenna 42 during a later iteration of FIG. 6). Processing circuitry 18 may, for example, calculate elliptical distance D between the VSWR measurement and a center of the reference cluster. The reference cluster may include a set of VSWR values (e.g., measurements) associated with free space state 70. VSWR values are complex numbers and may be represented on the complex plane (e.g., in a Smith chart). In practice, the VSWR values of the reference cluster are distributed in a substantially elliptical pattern on the complex plane, with a tighter distribution, clustering, or packing along a first (e.g., major) axis than along a second orthogonal (e.g., minor) axis. Put differently, the VSWR values of the reference cluster may be surrounded and enclosed by an ellipse in the complex plane (e.g., where an ellipse provides a more accurate fit around the VSWR values of the reference cluster than a 2D Gaussian fit that surrounds the values using a circle in the complex plane). As such, elliptical distance D may provide a more accurate and reliable measurement of the distance of the VSWR measurement from the center of the reference cluster than a Euclidean distance.

At operation 104, processing circuitry 18 may compare elliptical distance D to a threshold elliptical distance D_FS. An elliptical distance D that exceeds threshold elliptical distance D_FS (e.g., a D such that D>D_FS) may correspond to the VSWR measurement being excessively far from the center of reference cluster 129 and thus excessively uncharacteristic of the VSWR measurement being gathered while antenna 42 is in free space state 70 (e.g., based on the current knowledge that the processing circuitry has about the VSWR measurements that are characteristic of the antenna operating in the absence of external objects 58, as represented by the current reference cluster). Put differently, an elliptical distance D that exceeds threshold elliptical distance D_FS may be characteristic of the VSWR measurement having been gathered while antenna 42 remains in the occluded state. As such, if/when elliptical distance D exceeds threshold elliptical distance D_FS (e.g., when elliptical distance D is not less than threshold elliptical distance D_FS), processing circuitry 18 may determine, identify, or indicate that antenna 42 was still in the occluded state when the VSWR measurement was performed (e.g., that antenna 42 remains in the occluded state), and processing may proceed from operation 104 to operation 110 via path 106.

On the other hand, an elliptical distance D that is less than threshold elliptical distance D_FS (e.g., a D such that D<D_FS) may correspond to the VSWR measurement being sufficiently close to the center of reference cluster 129 and thus sufficiently characteristic of the VSWR measurement being gathered while antenna 42 is in free space state 70. Put differently, an elliptical distance D that is less than threshold elliptical distance D_FS (e.g., that is closer to the center of reference cluster 129 than a threshold) may be characteristic of the VSWR measurement having been gathered while antenna 42 is in the free space state. As such, if/when elliptical distance D is less than threshold elliptical distance D_FS (e.g., when elliptical distance D is not less than threshold elliptical distance D_FS), processing circuitry 18 may determine, identify, or indicate that antenna 42 has transitioned from the occluded state into free space state 70, and processing may proceed from operation 104 to operation 112 via path 108.

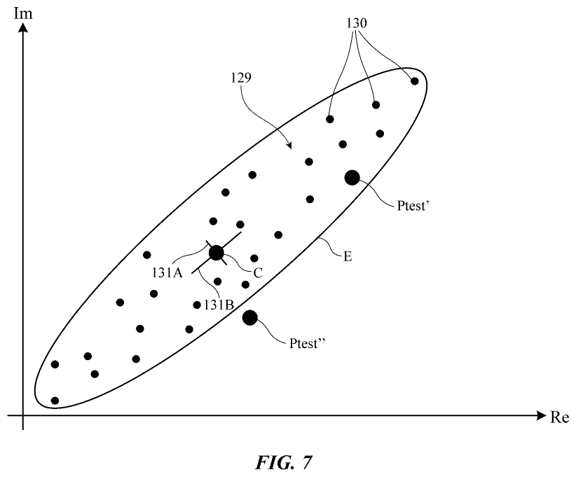

FIG. 7 illustrates a portion of a Smith chart showing one example of a reference cluster 129 of VSWR values 130 for antenna 42. Reference cluster 129 is sometimes also referred to herein as reference set 129 (e.g., a free space reference cluster or set). As shown in FIG. 7, the VSWR values 130 of antenna 42 in a free space state tend to be distributed in an elliptical pattern with greater spreading along a first (major) axis than along a second orthogonal (minor) axis. Processing circuitry 18 may define or characterize reference cluster 129 by an ellipse E on the complex plane. Ellipse E may surround and enclose all of the VSWR values 13 of reference cluster 129. Ellipse E may have a major axis in direction 131B and a minor axis in direction 131A orthogonal to direction 131B. The major axis and the minor axis may intersect at a center C of ellipse 132 and/or reference cluster 129.

Processing circuitry 18 may store any desired information identifying, defining, and/or characterizing reference cluster 129 for use in performing free space detection. For example, processing circuitry 18 may store each of VSWR values 130, may store one or more characteristics defining the ellipse E of reference cluster 129, and/or may store one or more metrics characterizing the distribution of VSWR values 130 within ellipse E. The characteristics may include, for example, a mean value μof reference cluster 129 (e.g., a mean value of the VSWR values 130 in reference cluster 129 and/or ellipse E) and a covariance Σ of reference cluster 129 (e.g., a 2-by-2 covariance matrix of reference cluster 129 and/or ellipse E that characterizes the shape of the cluster or ellipse along axes 131A and 131B). Processing circuitry 18 may use this information to calculate elliptical distance D for the current VSWR measurement.

Let the VSWR measurement generated by the VSWR sensor during the current iteration of the operations of FIG. 6 be denoted as VSWR measurement Pₜₑₛₜ (e.g., a vector characterizing or including the VSWR measurement). In this example, while performing operation 102 of FIG. 6, processing circuitry 18 may calculate elliptical distance D (e.g., a Mahalanobis distance or another type of elliptical distance on the complex plane) between the VSWR measurement and reference cluster 129 using the equation D=SQRT((Pₜₑₛₜ−μ)^{T}Σ⁻¹(Pₜₑₛₜ−μ)), where T is the transpose operator. Elliptical distance D is sometimes also referred to herein as Mahalanobis distance D or elliptic distance D. While performing operation 104 of FIG. 6, processing circuitry 18 may compare this generated elliptical distance D to threshold elliptical distance D_FS. Threshold elliptical distance D_FS may, for example, be represented on the complex plane by ellipse E of FIG. 7, by the smallest ellipse enclosing all of the VSWR measurements 130 of the reference cluster, or by an ellipse that is larger than the smallest ellipse enclosing all of the VSWR measurements 130 by a predetermined margin. When elliptical distance D is less than threshold elliptical distance D_FS, the corresponding VSWR measurement Pₜₑₛₜ will be located within (e.g., surrounded and enclosed by) ellipse E (or a similar threshold ellipse) on the complex plane. On the other hand, when elliptical distance D exceeds threshold elliptical distance D_FS, the corresponding VSWR measurement Pₜₑₛₜ will be located outside of or external to ellipse E (or a similar threshold ellipse) on the complex plane.

Consider a first example in which the VSWR sensor generates a VSWR measurement Pₜₑₛₜ′ during a given iteration of the operations of FIG. 6. In this example, VSWR measurement Pₜₑₛₜ′ lies within ellipse E (e.g., because VSWR measurement Pₜₑₛₜ′ was gathered while no external objects were present, overlapping, or adjacent to antenna 42). As such, after processing circuitry 18 calculates elliptical distance D for VSWR measurement Pₜₑₛₜ′, processing circuitry 18 will detect that the calculated elliptical distance D is less than elliptical distance D_FS and may determine, indicate, detect, or identify that antenna 42 has transitioned to free space state 70.

Now consider a second example in which the VSWR sensor generates a VSWR measurement Pₜₑₛₜ″ during a different iteration of the operations of FIG. 6. In this example, VSWR measurement Pₜₑₛₜ″ lies outside of ellipse E (e.g., because VSWR measurement Pₜₑₛₜ″ was gathered while a user's hand or another external object covers, overlaps, or is adjacent to antenna 42). As such, after processing circuitry 18 calculates elliptical distance D for VSWR measurement Pₜₑₛₜ″, processing circuitry 18 will detect that the calculated elliptical distance D exceeds elliptical distance D_FS and may determine, indicate, detect, or identify that antenna 42 remains in an occluded state. Note that VSWR measurement Pₜₑₛₜ″ is located closer to the center C of ellipse E when measured using a Euclidean distance than VSWR measurement Pₜₑₛₜ″ (e.g., a circle centered at VSWR measurement Pₜₑₛₜ′ has a shorter radius to center C than a circle centered at VSWR measurement Pₜₑₛₜ″), but is actually located farther from the center C of ellipse 132 when measured using elliptical distance D. Given the elliptical distribution of VSWR values 130 in reference cluster 129, elliptical distance D will thereby provide a more accurate comparison of the VSWR measurement to reference cluster 129 than Euclidean distance (e.g., VSWR measurement Pₜₑₛₜ″ is actually less likely to represent a VSWR measurement performed in a free space state than VSWR measurement Pₜₑₛₜ′, because VSWR measurement Pₜₑₛₜ″ is farther from center C in elliptical distance than VSWR measurement Pₜₑₛₜ′, despite VSWR measurement Pₜₑₛₜ″ being located closer to center C in Euclidean distance than VSWR measurement Pₜₑₛₜ′).

Returning to FIG. 6, at operation 112 (e.g., responsive to elliptical distance D being less than threshold elliptical distance D_FS), processing circuitry 18 may determine, detect, identify, or indicate that antenna 42 is operating in free space state 70 and may reduce or remove the maximum transmit power level backoff of antenna 42 (see, e.g., operation 98 of FIG. 5). Processing may then proceed to operation 118.

At operation 118, wireless circuitry 118 may wait for a time period TW before looping back to operation 100 over path 120 to perform additional VSWR measurements using antenna 42 (e.g., to continue to detect the RFE state of antenna 42 over time). Time period TW may, for example, be associated with the next scheduled transmission performed by antenna 42 and may, if desired, depend on the communication schedule for device 10 and/or antenna 42 (e.g., based on a transmit power control (TPC) window assigned to device 10). Time period TW may be 20-40 ms, in one non-limiting example.

On the other hand, at operation 110 (e.g., responsive to elliptical distance D exceeding threshold elliptical distance D_FS), processing circuitry 18 may determine, detect, identify, or indicate that antenna 42 is still operating in an occluded state and may increment a corresponding occluded state counter C_OCC (e.g., by setting C_OCC=C_OCC+1). Occluded state counter C_OCC may serve to count the number of times antenna 42 remains within and/or returns to an occluded state over a corresponding time period. Processing circuitry 18 may use occluded state counter C_OCC to identify a frequency with which antenna 42 remains within and/or returns to the occluded state over the corresponding time period (e.g., since the reference cluster was last updated).

At operation 114, processing circuitry 18 may compare the current value of occluded state counter C_OCC to a counter threshold C_MAX. If/when occluded state counter C_OCC remains below counter threshold C_MAX (e.g., C_OCC≤C_MAX), this may be indicative of the frequency with which antenna 42 remains within and/or returns to the occluded state over the corresponding time period being less than a corresponding frequency threshold, and processing may proceed to operation 118 via path 116. On the other hand, if/when occluded state counter C_OCC exceeds counter threshold C_MAX (e.g., C_OCC>C_MAX), this may be indicative of the frequency with which antenna 42 remains within and/or returns to the occluded state over the corresponding time period exceeding a corresponding frequency threshold, and processing may proceed to operation 124 via path 122.

In situations where antenna 42 remains within and/or returns to the occluded state too frequently (e.g., when C_OCC>C_MAX), this may be indicative of the current reference cluster 129 for antenna 42 not being sufficiently characteristic of antenna 42 operating in a free space state in the absence of external objects 58 that pose a risk of RFE limit violation (e.g., living external objects) given its current environmental loading conditions. This may occur, for example, when a different non-metallic removable device case/cover is placed over and remains over antenna 42 for an extended period of time. As such, at operation 124, processing circuitry 18 may perform a reference cluster update algorithm to update the current reference cluster 129 for antenna 42.

After updating reference cluster 129, at operation 126, processing circuitry 18 may reset occluded state counter C_OCC (e.g., may set C_OCC=0). Processing may then loop back to operation 100 via path 128 and processing circuitry 18 may use the updated reference cluster 129 for comparison to subsequent VSWR measurements for detecting a transition of antenna 42 to free space state 70.

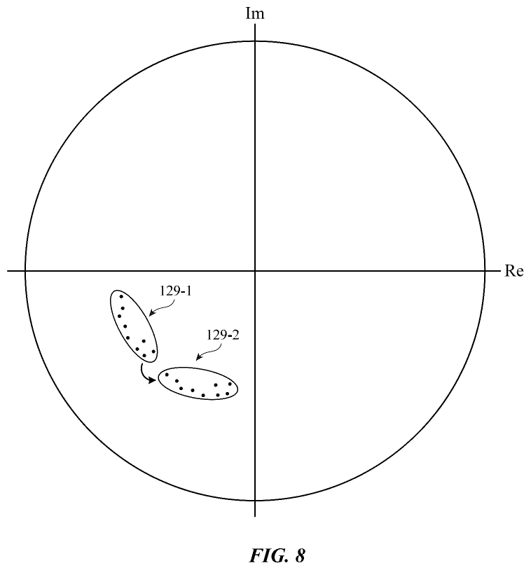

FIG. 8 is a Smith chart showing one example of how reference cluster 129 may change over time. As shown in FIG. 8, during a first time period, a given antenna 42 may be associated with a given reference cluster 129-1 characterizing the expected VSWR values of the antenna while operating in free space state 70. Processing circuitry 18 may use this reference cluster 129-1 for comparison to VSWR measurements during the first time period for detecting a transition of antenna 42 to the free space state.

Over time, a change in loading such as a change in loading produced by a change in a non-metallic removable device case/cover on device 10 may cause a shift in the VSWR values characterizing operation of the antenna in the free space state. By performing the reference cluster update algorithm (e.g., operation 124 of FIG. 6), processing circuitry 18 may generate an updated reference cluster 129-2 that better characterizes the VSWR values of antenna 42 after the change in loading associated with the non-metallic removable device case/cover. Processing circuitry 18 may then use updated reference cluster 129-2 for comparison to VSWR measurements during a second time period (e.g., after the change in non-metallic removable device case/cover) for detecting a transition of antenna 42 to the free space state during the second time period. In practice, a change in non-metallic removable device case/cover may produce a relatively large shift in the phase of reference cluster 129 (e.g., angle about the origin of FIG. 8) and a relatively small shift or no shift in the magnitude of reference cluster 129 (e.g., distance from the origin of FIG. 8). If desired, processing circuitry 18 may utilize this characteristic to validate an updated reference cluster (e.g., to filter out a potential outlier reference cluster) before storing the updated reference cluster for use in performing free space detection.

Note that in practice, the location of reference cluster 129 on the complex plane may also be frequency dependent. Reference clusters 129-1 and 129-2 may, for example, represent reference clusters of VSWR measurements gathered from radio-frequency signals transmitted by antenna 42 at the same frequency, frequency band, frequency range, or channel. If desired, processing circuitry 18 may store and utilize different respective reference clusters 129 for a given antenna 42, each corresponding to a different transmit frequency, frequency band, frequency range, or channel (e.g., for performing free space detection for antenna 42 while transmitting radio-frequency signals at the corresponding frequency, frequency band, frequency range, or channel).

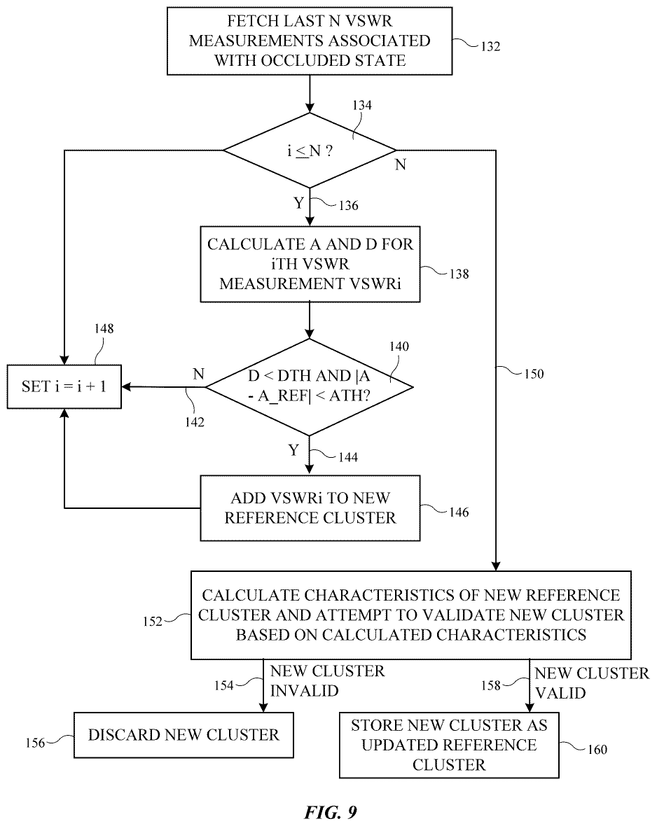

FIG. 9 is a flow chart of illustrative operations involved in updating the reference cluster 129 for a given antenna 42 (e.g., operations of a reference cluster update algorithm for antenna 42). The operations of FIG. 9 may, for example, be performed while processing operation 124 of FIG. 6.

At operation 132, processing circuitry 18 may fetch, read, receive, gather, and/or otherwise identify the last (most recent) N VSWR measurements (e.g., VSWR measurements Pₜₑₛₜ of FIG. 7) associated with antenna 42 operating in the occluded state (e.g., the last N VSWR measurements having elliptical distances D to the center C of the current reference cluster 129 that exceed threshold elliptical distance D_FS). N may be any desired integer greater than or equal to one. The N fetched VSWR measurements may form a set of N VSWR measurements. Each VSWR measurement in the set is denoted as a VSWR measurement VSWRi, where i is an integer index (e.g., from 1 to N).

Processing circuity 18 may begin to iterate through operations 134-148 for each of the N VSWR measurements VSWRi in the set. At operation 134, processing circuitry 18 may determine whether the index i of VSWR measurement VSWRi is less than or equal N. If/when index i is less than or equal to N, this is indicative of at least one VSWRi measurement in the set still needing to be processed and processing may proceed to operation 138 via path 136. If/when index i exceeds N, this is indicative of all N VSWR measurements VSWRi having already been processed.

At operation 138, processing circuitry 18 may calculate elliptical distance D for the i^{th} VSWR measurement VSWRi in the set. Processing circuitry 18 may calculate elliptical distance D, for example, using the equation D=SQRT((VSWRi−μ_REF)^{T}(Σ_REF)⁻¹(VSWRi−μ_ref)), where μ_REF is the mean value of the current reference cluster 129 and Σ_REF is the covariance of the current reference cluster 129. Processing circuitry 18 may also calculate an amplitude (magnitude) value A for VSWR measurement VSWRi. Processing circuitry 18 may calculate (e.g., generate, output, compute, identify, determine, etc.) amplitude value A, for example, using the equation A=dB20|(VSWRi)|.

At operation 140, processing circuitry 18 may compare the generated elliptical distance D for the i^{th} VSWR measurement VSWRi to an elliptical distance update threshold DTH associated with the current reference cluster. Processing circuitry 18 may also compare the value |A−A_REF| to an amplitude (magnitude) threshold ATH. Value A_REF may be an amplitude (magnitude) value associated with the current reference cluster 129. If/when elliptical distance D is less than elliptical distance update threshold DTH and the value |A−AREF|<ATH, processing may proceed to operation 146 via path 144. This may occur when, for example, the i^{th} VSWR measurement VSWRi is indicative of the type of VSWR measurement that would be produced due to a change in non-metallic removable device case/cover over the antenna (as opposed to another type of change in loading condition). The value |A−AREF| being less than amplitude threshold ATH may, for example, indicate that the amplitude of VSWR measurement VSWRi has not changed significantly from the amplitude of the reference cluster in the complex plane (e.g., because changes in non-metallic removable device cases/covers are associated with relatively large changes in angle but not relatively large changes in amplitude, as shown by reference clusters 129-1 and 129-2 of FIG. 8). The elliptical distance D being less than elliptical distance update threshold DTH may, for example, indicate that VSWR measurement VSWRi is sufficiently close to the center of the current reference cluster (e.g., helping to eliminate potential outlier measurements VSWRi associated with an occluded state but that are too far from the current reference cluster 129 to be useful in generating an updated reference cluster).

At operation 146, processing circuitry 18 may add (e.g., accumulate or assign) the i^{th} VSWR measurement VSWRi to a new reference cluster (sometimes also referred to herein simply as a new cluster). The new reference cluster may include only VSWR measurements VSWRi that pass the conditions of operation 140 (e.g., VSWR measurements VSWRi that exhibit relatively small magnitude shifts from the current reference cluster and that are not outliers) or may include a mix/combination of VSWR measurements VSWRi that pass the conditions of operation 140 and one or more VSWR measurements from the current reference cluster 129. Processing circuitry 18 may also increment a new reference cluster counter N_CLUSTER that indicates the size of the new reference cluster (e.g., the number of VSWR measurements already included in the new reference cluster). The new reference cluster may be stored in storage circuitry for potential use as an updated reference cluster (e.g., for subsequent free space detection) after the new reference cluster has been validated. Processing may proceed to operation 148 and index i may be incremented (e.g., processing circuitry 18 may set i=i+1) before looping back to operation 134 as the remaining VSWR measurements VSWRi in the set of N VSWR measurements are processed.

If/when the elliptical distance D for a VSWR measurement VSWRi is greater than or equal to elliptical distance update threshold DTH and/or the value |A−AREF| is greater than or equal to amplitude threshold ATH while processing operation 140, this may be indicative of the i^{th} VSWR measurement VSWRi not being suitable or reliable for inclusion in the new reference cluster (e.g., because the VSWR measurement is an outlier value and/or is not the type of VSWR measurement indicative of a non-metallic removable device case/cover change over the antenna). In these cases, processing may proceed from operation 140 to operation 148 via path 142.

Once all N VSWR measurements VSWRi in the set have been processed during an iteration of operations 138-148 (e.g., when i>N), processing may proceed from operation 134 to operation 152 via path 150. At operation 152, processing circuitry 18 may calculate one or more characteristics of the new reference cluster. Processing circuitry 18 may then attempt to validate the new reference cluster based on the one or more characteristics. If/when processing circuitry 18 is able to validate the new reference cluster (e.g., when the new reference cluster is valid or verified), processing may proceed to operation 160 via path 158. If/when processing circuitry 18 is unable to validate the new reference cluster (e.g., when the new reference cluster is invalid or unverified), processing may proceed from operation 152 to operation 156 via path 154.

At operation 160 (e.g., responsive to validation of the new reference cluster), processing circuitry 18 may store the new reference cluster as the updated reference cluster. Processing circuitry 18 may then use the updated reference cluster as the reference cluster that is compared to later VSWR measurements (e.g., at operation 88 of FIG. 5, operations 102-104 of FIG. 6, etc.) during free space detection for antenna 42. Processing may then proceed to operation 126 of FIG. 6 if desired. The updated reference cluster may more accurately characterize the expected VSWR values of antenna 42 under its current loading (e.g., by a non-metallic removable device case/cover) than the previous reference cluster. In this way, the reference cluster may continue to be updated over time as the loading of antenna 42 changes over time, allowing the antenna to maximize its transmit power level as much as possible (e.g., increasing transmit performance) without violating regulatory limits on RFE.

At operation 156 (e.g., responsive to the new reference cluster being invalid), processing circuitry 18 may discard the new reference cluster (e.g., because the new reference cluster is not suitable for use as an updated reference cluster during subsequent free space detection).

The loop of operations 134-148 in FIG. 9 involves processing circuitry 18 verifying or validating the suitability of individual VSWR measurements VSWRi from the set of N VSWR measurements for inclusion in a potential updated reference cluster. While each of the VSWR measurements VSWRi included in the new reference cluster may be suitable for use in an updated reference cluster on their own, in some situations, the accumulation of all of the VSWR measurements in the new reference cluster may not be collectively suitable for use as the updated reference cluster. The validation performed at operation of FIG. 9 may serve to validate the suitability of the entire new reference cluster for use as the updated reference cluster.

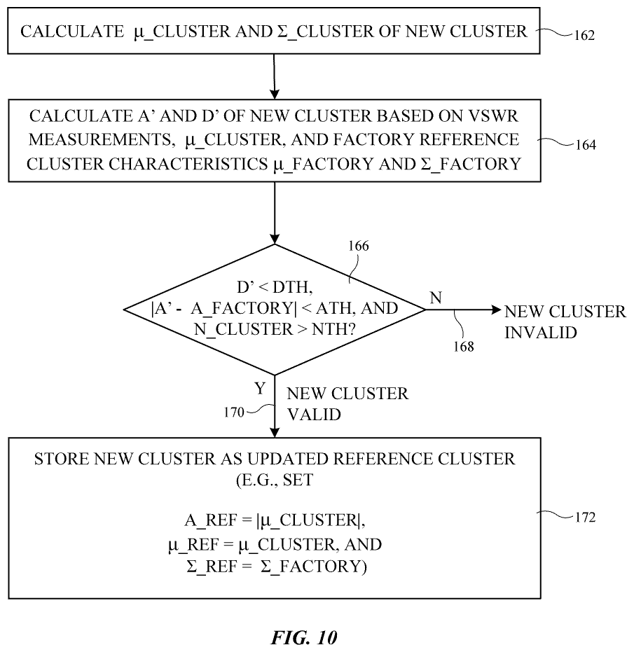

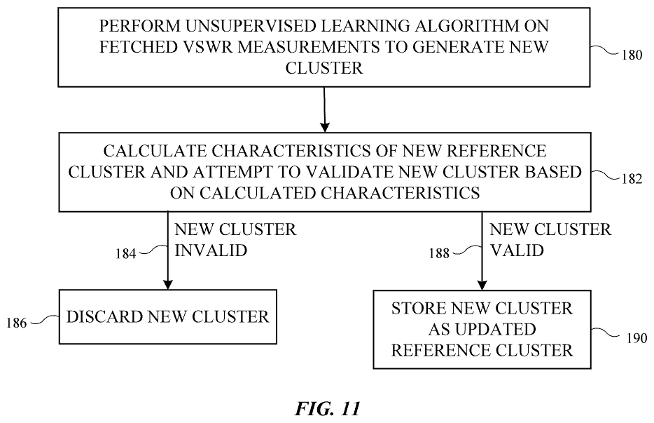

FIGS. 10 and 11 are flow charts of illustrative operations that may be performed by processing circuitry 18 to validate a new reference cluster as the updated reference cluster for use during free space detection. The operations of FIGS. 10 and 11 may, for example, be performed while processing operation 152 of FIG. 9. FIG. 10 illustrates a first example in which processing circuitry 18 validates a new reference cluster based on a density of the new reference cluster and a factory reference cluster stored in the wireless circuitry (e.g., as generated while processing operation 80 of FIG. 5). At a high level, the operations of FIGS. 10 and 11 may, for example, serve to validate or verify that the new reference cluster is sufficiently similar to the factory reference cluster for the new reference cluster to be trusted as an updated reference cluster for use during subsequent free space detection. New reference clusters that are excessively different from the factory reference cluster may, for example, represent an outlier reference cluster that is unreliable for use in subsequent free space detection.

For example, at operation 162 of FIG. 10, processing circuitry 18 may calculate (e.g., compute, generate, output, identify, etc.) a mean value μ_CLUSTER and a covariance Σ_CLUSTER of the new reference cluster (e.g., a two-by-two covariance matrix of the new reference cluster). Mean value μ_CLUSTER and a covariance Σ_CLUSTER may, for example, serve to define or characterize the new reference cluster (e.g., mean value μ_CLUSTER and a covariance Σ_CLUSTER may be sufficient to use the new reference cluster as an updated reference cluster for generating elliptical distance D to VSWR measurements while performing free space detection).

At operation 164, processing circuitry 18 may calculate an amplitude (magnitude) value A′ and an elliptical distance D′ based on the VSWR measurements VSWRi in the new reference cluster and based on the factory reference cluster. For example, processing circuitry 18 may calculate amplitude value A′ using the equation A′=dB20|VSWRi| and may calculate elliptical distance D′ using the equation D′=Mahal(μ_CLUSTER, μ_FACTORY, Σ_CLUSTER), where μ_FACTORY is the mean of the factory reference cluster, Σ_CLUSTER is the covariance of the factory reference cluster, and Mahal( ) computes the Mahalanobis distance between the new reference cluster and the factory reference cluster based on μ_CLUSTER, μ_FACTORY, and Σ_CLUSTER.

At operation 166, processing circuitry 18 may compare the new reference cluster to the factory reference cluster to determine whether the new reference cluster is suitable for use as the updated reference cluster. If the new reference cluster is excessively different or far from the factory reference cluster (e.g., differs from the factory reference cluster by more than a threshold amount), this may be indicative of the new reference cluster being an outlier cluster that is unsuitable (invalid) for comparison to later VSWR measurements during free space detection. If the new reference cluster is sufficiently similar (close) to the factory reference cluster (e.g., differs from the factory reference cluster by less than the threshold amount), this may be indicative of the new reference cluster being suitable (valid) for comparison to later VSWR measurements during free space detection.

Processing circuitry 18 may perform this comparison, for example, by comparing elliptical distance D′ to elliptical distance threshold DTH (e.g., to determine whether D′<DTH), by comparing the value |A′−AFACTORY| to amplitude threshold ATH, and/or by comparing N_CLUSTER (e.g., the size of the new reference cluster or, equivalently, the number of VSWR measurements VSWRi in the new reference cluster) to a size threshold NTH. Value AFACTORY may be associated with the amplitude (magnitude) of the factory reference cluster. Size threshold NTH may, for example, be selected to specify a minimum suitable density of the new reference cluster (e.g., the minimum size of the new reference cluster or, equivalently, the minimum number of VSWR measurements VSWRi in the new reference cluster) needed for the new reference cluster to be trusted for use as the updated reference cluster. Size threshold NTH may be any desired integer greater than one, ten, twenty, fifty, 100, 1000, etc.

Processing circuitry 18 may identify a new reference cluster that is sufficiently close/similar to the factory reference cluster and that is sufficiently dense (e.g., that contains a sufficient number of VSWR measurements) as a valid reference cluster that can be stored and used as the updated reference cluster. Processing circuitry 18 may identify a new reference cluster that is too far/different from the factory reference cluster and/or that is insufficiently dense (e.g., that contains an insufficient number of VSWR measurements or that is excessively sparse) as an invalid reference cluster. As such, if/when D′>DTH, |A′−AFACTORY|≥ATH, and/or N_CLUSTER≤NTH, processing circuitry 18 may determine or indicate that the new reference cluster is invalid and processing may proceed from operation 166 to operation 156 of FIG. 9 via path 168. On the other hand, if/when D′<DTH, |A′−AFACTORY|<ATH, and/or N_CLUSTER>NTH, processing circuitry 18 may determine or indicate that the new reference cluster is valid and processing may proceed from operation 166 to operation 172 via path 170.

At operation 172, processing circuitry 18 may store the new reference cluster as the updated reference cluster for use during subsequent free space detection. For example, processing circuitry 18 may store the mean, amplitude, covariance, VSWR measurements, and/or other metrics of the new cluster as an updated reference cluster 129 used to perform subsequent free space detection. If desired, processing circuitry 18 may set the amplitude A_REF of the (updated) reference cluster equal to |μ_CLUSTER|, may set μ_REF of the (updated) reference cluster equal to μ_CLUSTER, and may set the covariance Σ_REF of the (updated) reference cluster equal to Σ_FACTORY, and may use these stored values of A_REF, μ_REF, and Σ_REF for use when performing further updates to the reference cluster as the loading conditions of antenna 42 changes over time (e.g., while processing later iterations of FIG. 9).

The example of FIG. 10 is illustrative and non-limiting. In another implementation, shown in FIG. 11, processing circuitry 18 may generate the new reference cluster based on an unsupervised learning algorithm. For example, at operation 180 of FIG. 11, processing circuitry 18 may perform an unsupervised learning algorithm on the set of N VSWR measurements VSWRi (e.g., as fetched while processing operation 132 of FIG. 9). The unsupervised learning algorithm may output a new reference cluster, which may then be validated while processing the remaining operations of FIG. 11. The unsupervised learning algorithm may be, for example, a density-based spatial clustering of applications with noise (DBSCAN) algorithm that outputs the new reference cluster based on the set of N VSWR measurements VSWRi. The unsupervised learning algorithm may, for example, process the set of N VSWR measurements VSWRi to identify which of the set of VSWR measurements VSWRi are sufficiently similar to the type of VSWR measurement associated with a non-metallic removable device case/cover change and/or the current reference cluster to be acceptable for inclusion in the new reference cluster.

As one example, the unsupervised learning algorithm may perform a DBSCAN algorithm that operates on the inputs dist_fun=Mahal(p1, p2, Σ_FACTORY), eps=DTH, and minPts=ATH*B, where B is the set of N fetched VSWR measurements VSWRi. Processing circuitry 18 may then identify, as the new reference cluster, the cluster output by the unsupervised learning algorithm that includes the most points (VSWR measurements). Processing circuitry 18 may then calculate μ_CLUSTER and Σ_CLUSTER from the identified cluster, and may calculate A′ and D′ based on the calculated μ_CLUSTER and Σ_CLUSTER, B, and Σ_FACTORY (e.g., as described above in connection with operation 164 of FIG. 10).

At operation 182, processing circuitry 18 may then validate the new reference cluster output by the unsupervised learning algorithm (similar to operation 152 of FIG. 9). If/when processing circuitry 18 determines that the new reference cluster is valid, processing proceeds to operation 190 via path 188 and processing circuitry 18 may store the new reference cluster as the updated reference cluster. If/when processing circuitry 18 determines that the new reference cluster is invalid, processing proceeds to operation 186 via path 184 and processing circuitry 18 may discard the new reference cluster.

The example of FIGS. 5-11 is illustrative and non-limiting. If desired, non-occluded measurements may also be accumulated by device 10 in the background to fine-adjust the reference cluster in the long term (e.g., to correct for long term/lifetime measurement drift). This is sometimes also referred to herein as performing a slow learning algorithm. In these implementations, if/when the change in Mahalanobis distance is below a threshold (e.g., is small) and the calculated cluster of points falls in a specific region relative to the factory cluster, the calculated cluster of points may be set as the new (updated) reference cluster to use for occlusion detection. The slow learning algorithm is based on clustering the non-occluded VSWR data with small drift (e.g., that does not cause a sudden occlusion triggering) with unsupervised learning (e.g., DBSCAN).

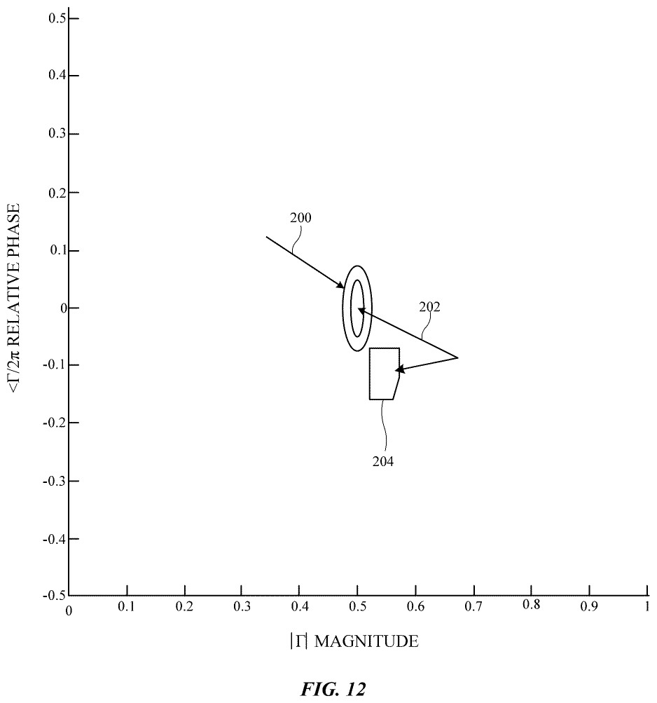

Based on experimental observation, non-metallic removable device cases (or the absence of any removable device case) will produce VSWR measurements that fall into one of two different regions. FIG. 12 is a plot of VSWR measurements (e.g., in relative phase as a function of magnitude of reflection coefficient Γ) showing how VSWR measurements performed in the presence of a non-metallic removable device case (or the absence of any removable device case) may fall into one of two different regions. As shown in FIG. 12, device 10 may have as stored factory reference cluster 200. When device 10 performs a VSWR measurement while device 10 is in a non-metallic removable device case or while device 10 is not in any removable device case, the VSWR measurements will most likely fall in one of two different regions 202 (e.g., within factory reference cluster 200 or within a predetermined region 204 outside of factory reference cluster 200). Both regions 202 may represent valid regions for VSWR measurements to be used for learning/updating the reference cluster stored on device 10 (e.g., for subsequent free space detection).

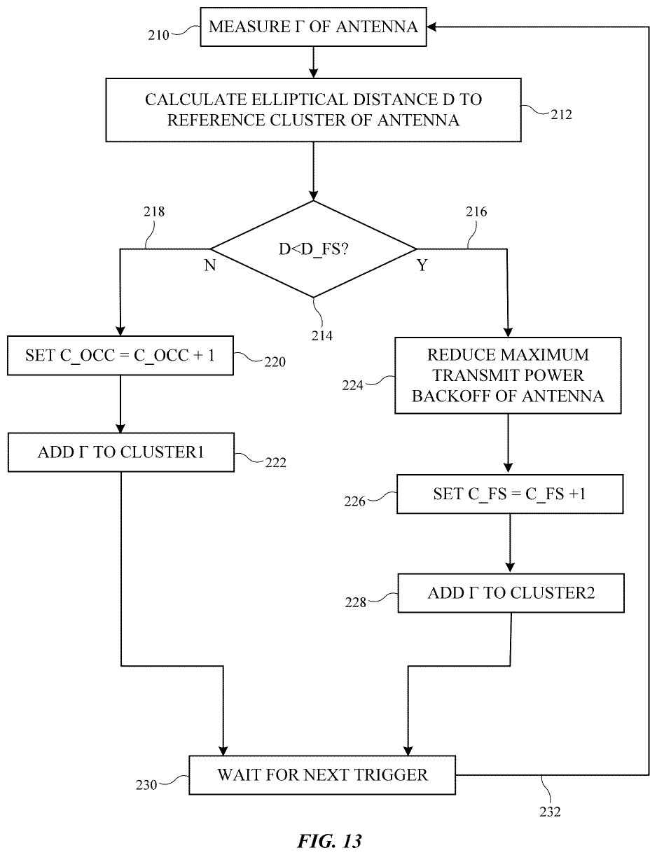

FIG. 13 is a flow chart of illustrative operations that may be performed in these implementations (e.g., instead of or in addition to the operations of FIG. 6). The operations of FIG. 13 may, for example, be performed in response to a trigger issued upon enablement of occlusion detection. If/when occlusion detection is not enabled, device 10 may wait for time TW before reassessing whether occlusion detection is enabled. Device 10 may also wait for time TW after triggering the operations of FIG. 13 before reassessing whether occlusion detection is enabled. Device 10 may be in an occluded state such as the extremity state at the beginning of FIG. 13.

As shown in FIG. 13, at operation 210, the VSWR sensor 67 of antenna 42 may measure the reflection coefficient Γ (or another impedance metric associated with or including VSWR) of antenna 42 while the antenna transmits radio-frequency signals (see, e.g., operation 100 of FIG. 6). As used herein, the term VSWR measurement may include measurements of reflection coefficient Γ.

At operation 212, processing circuitry 18 may calculate the elliptical distance D between the measured reflection coefficient (or other impedance metric associated with or including VSWR) and the current reference cluster of antenna 42 (see, e.g., operation 102 of FIG. 6). The reference cluster may have a corresponding mean μ_REF and covariance Σ_REF.

At operation 214, processing circuitry 18 may compare elliptical distance D to threshold elliptical distance D_FS (see, e.g., operation 104 of FIG. 6). If/when D<D_FS, processing may proceed to operation 224 via path 216. If/when D≥D_FS, processing may proceed to operation 220 via path 218.

At operation 220 (e.g., responsive to elliptical distance D exceeding threshold elliptical distance D_FS), processing circuitry 18 may determine that antenna 42 is still operating in an occluded state and may increment occluded state counter C_OCC (see, e.g., operation 110 of FIG. 6).

At operation 222, processing circuitry 18 may add the measured reflection coefficient (or other impedance metric associated with or including VSWR) to a first cluster (set) of measurements, denoted as CLUSTER1. CLUSTER1 may represent occluded measurements (e.g., measurements while antenna 42 is in an occluded state). Processing may then proceed to operation 230, at which device 10 waits until the next trigger (e.g., after time TW has elapsed and in response to occlusion detection being enabled). When the next trigger occurs, processing may loop back to operation 210 via path 232.

On the other hand, at operation 224 (e.g., responsive to elliptical distance D being less than threshold elliptical distance D_FS), processing circuitry 18 may determine, detect, identify, or indicate that antenna 42 is operating in a free space state and may reduce or remove the maximum transmit power level backoff of antenna 42 (see, e.g., operation 112 of FIG. 6).

At operation 226, processing circuitry 18 may increment a free space state counter C_FS (e.g., by setting C_FS=C_FS+1). Free space state counter C_FS is indicative of the number of measurements that correspond to the device being in a free space state.

At operation 228, processing circuitry 18 may add the measured reflection coefficient (or other impedance metric associated with or including VSWR) to a second cluster (set) of measurements, denoted as CLUSTER2. CLUSTER2 may represent non-occluded measurements (e.g., measurements while antenna 42 is in a non-occluded state). Processing may then proceed to operation 230.

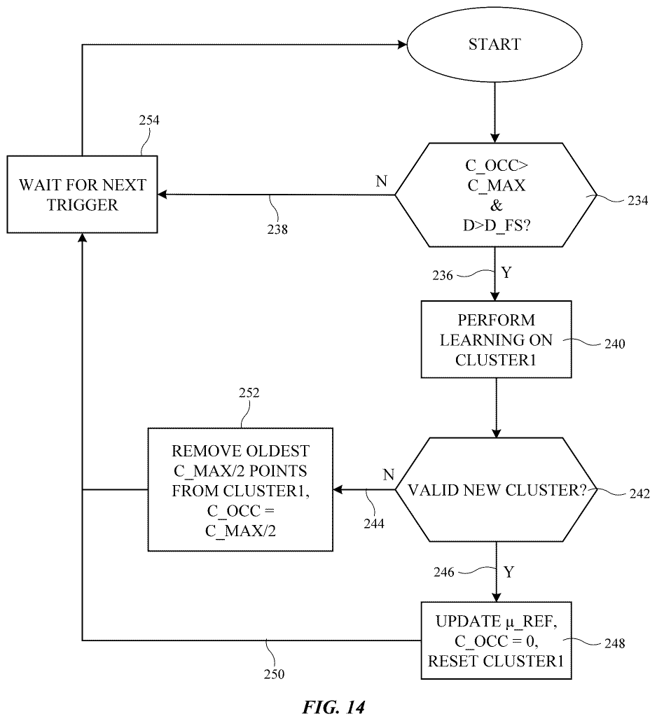

Processing circuitry 18 may use CLUSTER1 to trigger and perform reference cluster learning. Processing circuitry 18 may use CLUSTER2 to trigger and perform slow learning (e.g., to mitigate long term or slow measurement drift). FIG. 14 is a flow chart of illustrative operations involved in using CLUSTER1 to trigger reference cluster learning.

At operation 234, processing circuitry 18 may determine whether C_OCC>C_MAX and D>D_FS. If/when both C_OCC>C_MAX and D>D_FS, processing may proceed to operation 240 via path 236. If/when C_OCC≤C_MAX and/or D≤D_FS, processing may proceed to operation 254 via path 238. At operation 254, processing circuitry 18 may wait for the next trigger before looping back to operation 234.

At operation 240, processing circuitry 18 may perform a reference cluster learning algorithm on CLUSTER1 (e.g., to potentially use CLUSTER1 as a new/updated reference cluster).

At operation 242, processing circuitry 18 may determine whether the CLUSTER1 as output by the learning algorithm is valid as a new/updated reference cluster (see, e.g., validation at operation 152 of FIG. 9 or at operation 182 of FIG. 11). If/when the new/updated reference cluster is invalid, processing may proceed to operation 252 via path 244. If/when the new/updated reference cluster is valid, processing may proceed to operation 248 via path 246.

At operation 252, processing circuitry 18 may remove the oldest half of the measurements in CLUSTER1 (e.g., the oldest C_MAX/2 points) from CLUSTER1, such that the size of CLUSTER1 is equal to C_MAX/2. Processing may then proceed to operation 254.

At operation 248, processing circuitry 18 may update the mean μ_REF of its current reference cluster to the mean μ_REF of the new/updated reference cluster, may reset occluded state counter C_OCC, and may reset CLUSTER1. Processing may then proceed to operation 254 via path 250.

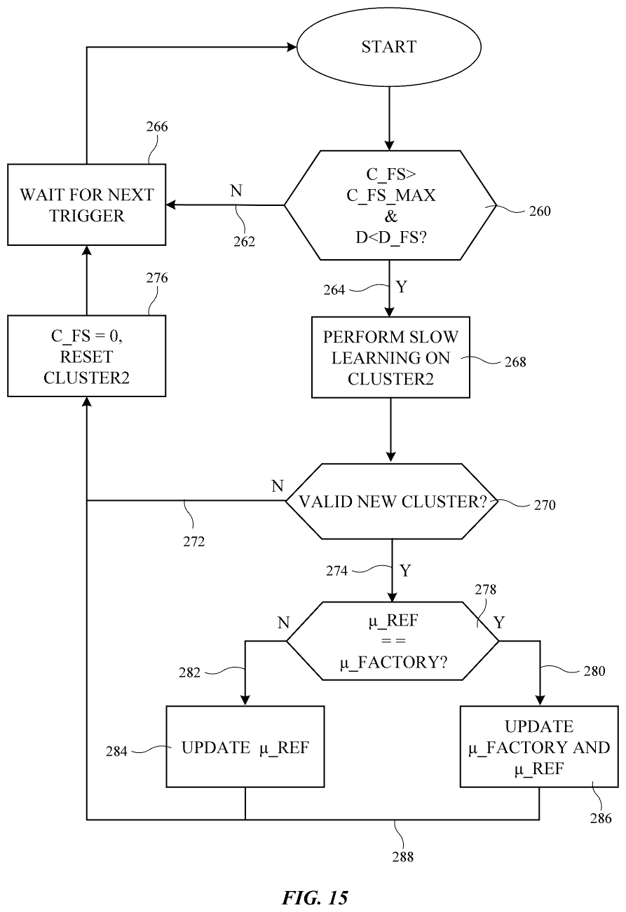

FIG. 15 is a flow chart of illustrative operations involved in using CLUSTER2 to trigger slow learning.

At operation 260, processing circuitry 18 may determine whether C_FS>C_FS_MAX, where C_FS_MAX is a counter threshold for free space state counter C_FS, and whether D<D_FS. If/when both C_FS>C_FS_MAX and D<D_FS, processing may proceed to operation 268 via path 264. If/when C_FS≤C_FS_MAX and/or D≥D_FS, processing may proceed to operation 266 via path 262. At operation 266, processing circuitry 18 may wait for the next trigger before looping back to operation 260.

At operation 268, processing circuitry 18 may perform a slow learning algorithm on CLUSTER2 (e.g., to mitigate long term drift in free space measurements performed by the device).

At operation 270, processing circuitry 18 may determine whether the CLUSTER2 as output by the learning algorithm is valid as a new/updated reference cluster (see, e.g., validation at operation 152 of FIG. 9 or at operation 182 of FIG. 11). If/when the new/updated reference cluster is invalid, processing may proceed to operation 276 via path 272. If/when the new/updated reference cluster is valid, processing may proceed to operation 278 via path 274.

At operation 276, processing circuitry 18 may reset free space state counter C_FS and may reset CLUSTER2. Processing may then proceed to operation 266.

At operation 278, processing circuitry 18 may determine whether the mean μ_REF of the valid new cluster is equal to the mean μ_FACTORY of the factory reference cluster (e.g., factory reference cluster 200 of FIG. 12). If/when μ_REF=μ_FACTORY, processing may proceed to operation 286 via path 280. If/when μ_REF is different from μ_FACTORY, processing may proceed to operation 284 via path 282.

At operation 286, processing circuitry 18 may update μ_REF and μ_FACTORY based on the valid new cluster. This may, for example, update the μ_FACTORY used in subsequent reference cluster learning to account for long term slow drift in free space measurements performed by the corresponding antenna. Processing may then loop back to operation 276 via path 288.

At operation 284, processing circuitry 18 may update μ_REF (but not μ_FACTORY) based on the valid new cluster (e.g., leaving the current μ_FACTORY in place for use in subsequent reference cluster learning). Processing may then loop back to operation 276 via path 288.

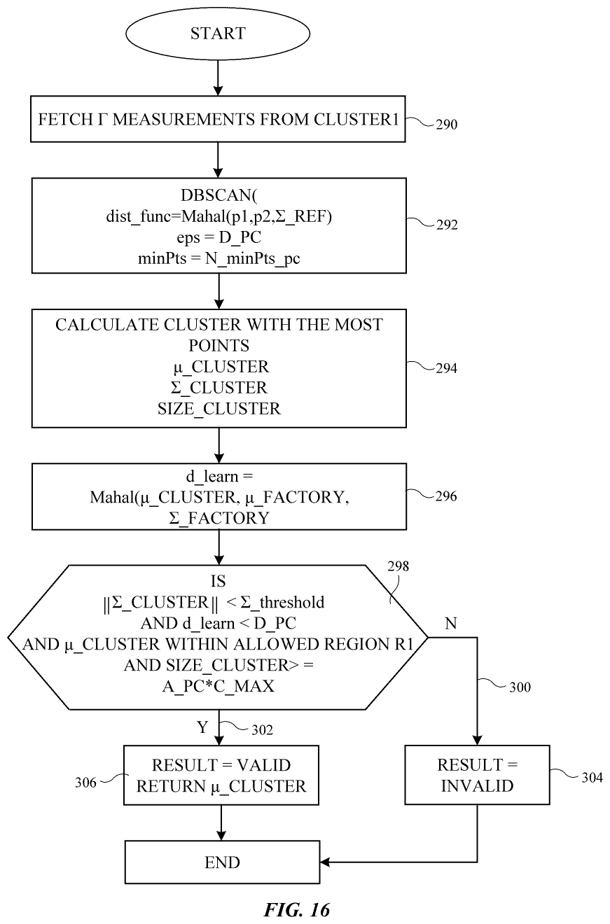

FIG. 16 is a flow chart of illustrative operations involved in performing a reference cluster learning algorithm on CLUSTER1. The operations of FIG. 16 may, for example, be performed while processing operations 240 and 242 of FIG. 14.

At operation 290, processing circuitry 18 may fetch the reflection coefficient Γ measurements from CLUSTER1.

At operation 292, processing circuitry 18 may perform an unsupervised learning algorithm on the fetched measurements. For example, processing circuitry 18 may perform a DBSCAN algorithm that is a function of a distance function dist_func=Mahal(p1, p2, Σ_REF), an eps value equal to D_PC (e.g., a threshold elliptical distance), and minPts value equal to N_minPts_pc. Put differently, the DBSCAN algorithm may form a set of candidate clusters from the points (measurements) in CLUSTER1.

At operation 294, processing circuitry 18 may identify and/or calculate the candidate cluster output by the DBSCAN that includes the most points. Processing circuitry 18 may generate Σ_CLUSTER, μ_CLUSTER, and SIZE_CLUSTER for the candidate cluster with the most points (e.g., where SIZE_CLUSTER identifies the size of the cluster).

At operation 296, processing circuitry 18 may set a value d_learn=Mahal(μ_CLUSTER, μ_FACTORY, Σ_FACTORY) and may use value d_learn during subsequent processing.

At operation 298, processing circuitry 18 may determine whether ||Σ_CLUSTER||<Σ_TH (where Σ_TH is a threshold covariance), whether d_learn<D_PC (e.g., a threshold elliptical distance), whether μ_CLUSTER is within an allowed region R1 (see, e.g., regions 202 of FIG. 12), and whether SIZE_CLUSTER≥A_PC*C_MAX (e.g., a threshold size). If/when all of these conditions are true, this means that both density and magnitude shift criteria are satisfied and the learned new/updated cluster may be set as the current (updated) reference cluster. Processing may then proceed to operation 306 via path 302. If/when one or more of these conditions are false, this means that one or both of the density and magnitude shift criteria are unsatisfied and processing may proceed to operation 304 via path 300.

At operation 304, processing circuitry 18 may determine that the learned new/updated cluster (e.g., as generated based on CLUSTER1) is invalid. Processing may then proceed to operation 232 of FIG. 14.

At operation 306, processing circuitry 18 may determine that the learned new/updated cluster (e.g., as generated based on CLUSTER1) is valid. Processing circuitry 18 may return μ_CLUSTER for the learned cluster and processing may proceed to operation 248 of FIG. 14 (e.g., where μ_CLUSTER forms the updated μ_REF at operation 248 of FIG. 14).

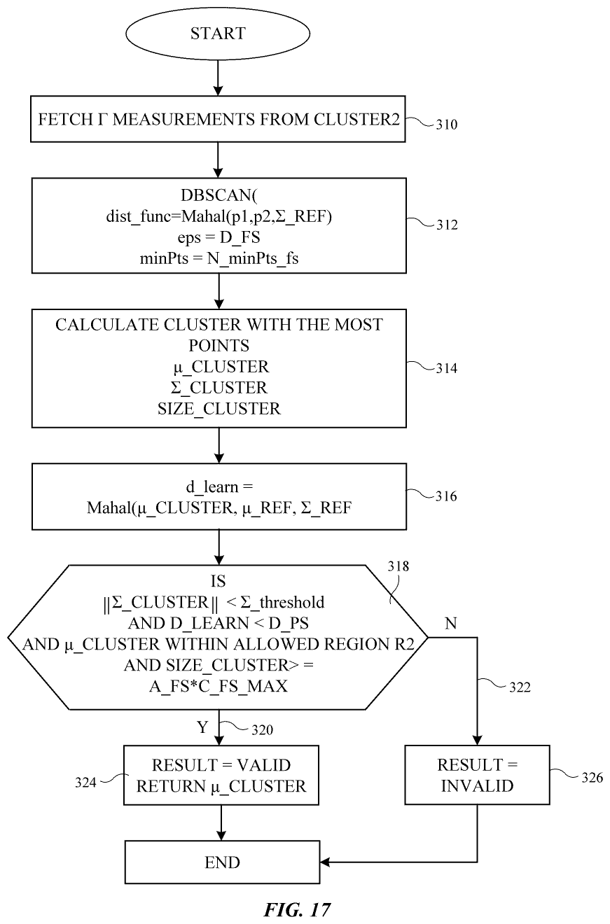

FIG. 17 is a flow chart of illustrative operations involved in performing a slow cluster learning algorithm on CLUSTER2. The operations of FIG. 17 may, for example, be performed while processing operations 268 and 270 of FIG. 15.

At operation 310, processing circuitry 18 may fetch the reflection coefficient Γ measurements from CLUSTER2.

At operation 312, processing circuitry 18 may perform an unsupervised learning algorithm on the fetched measurements. For example, processing circuitry 18 may perform a DBSCAN algorithm that is a function of a distance function dist_func=Mahal(p1, p2, Σ_REF), an eps value equal to D_FS, and minPts value equal to N_minPts_fs. Put differently, the DBSCAN algorithm may form a set of candidate clusters from the points (measurements) in CLUSTER2.

At operation 316, processing circuitry 18 may identify and/or calculate the candidate cluster output by the DBSCAN that includes the most points. Processing circuitry 18 may generate Σ_CLUSTER, μ_CLUSTER, and SIZE_CLUSTER for the candidate cluster with the most points.

At operation 318, processing circuitry 18 may set a value d_learn=Mahal(μ_CLUSTER, μ_REF, Σ_REF) and may use value d_learn during subsequent processing.

At operation 318, processing circuitry 18 may determine whether ||Σ_CLUSTER||<Σ_TH, whether d_learn<D_FS, whether μ_CLUSTER is within an allowed region R2 (see, e.g., regions 202 of FIG. 12), and whether SIZE_CLUSTER≥A_FS*C_FS_MAX (e.g., a threshold size). If/when all of these conditions are true, this means that both density and magnitude shift criteria are satisfied. Then, if the current reference cluster is the factory reference cluster, processing circuitry 18 may update the factory reference cluster accordingly. On the other hand, if the current reference cluster is not the factory reference cluster, then processing circuitry 18 may update the reference cluster accordingly. Processing may then proceed to operation 324 via path 320. If/when one or more of these conditions are false, this means that one or both of the density and magnitude shift criteria are unsatisfied and processing may proceed to operation 326 via path 322.

At operation 326, processing circuitry 18 may determine that the learned new/updated cluster (e.g., as generated based on CLUSTER2) is invalid. Processing may then proceed to operation 276 of FIG. 15.

At operation 324, processing circuitry 18 may determine that the learned new/updated cluster (e.g., as generated based on CLUSTER2) is valid. Processing circuitry 18 may return μ_CLUSTER for the learned cluster and processing may proceed to operation 274 of FIG. 15.

In one example, a method of operating wireless circuitry includes: transmitting, using a transmitter while subject to a maximum transmit power level, radio-frequency signals over an antenna; performing, using a sensor while the antenna is in an occluded state, a reflection coefficient measurement based on the radio-frequency signals; calculating, using one or more processors, a Mahalanobis distance between the reflection coefficient measurement and a reference cluster of reflection coefficient measurements; adding, using the one or more processors, the reflection coefficient measurement to a first cluster when the Mahalanobis distance is less than a first threshold; adding, using the one or more processors, the reflection coefficient measurement to a second cluster when the Mahalanobis distance exceeds the first threshold; updating, responsive to a size of the first cluster exceeding a second threshold and the Mahalanobis distance exceeding the first threshold, the reference cluster by inputting the first cluster to an unsupervised learning algorithm; updating, responsive to a size of the second cluster exceeding a third threshold and the Mahalanobis distance being less than the first threshold, the reference cluster by inputting the second cluster to the unsupervised learning algorithm; and adjusting, using the one or more processors, the maximum transmit power level based on the Mahalanobis distance.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. A method of operating wireless circuitry, the method comprising:
transmitting, using an antenna, radio-frequency signals subject to a maximum transmit power level;
performing, using a sensor, a voltage standing wave ratio (VSWR) measurement based on the radio-frequency signals transmitted by the antenna; and
adjusting, using one or more processors, the maximum transmit power level based on an elliptical distance between the VSWR measurement and a reference set of VSWR values associated with the antenna.

2. The method of claim 1, wherein adjusting the maximum transmit power level comprises increasing the maximum transmit power level when the elliptical distance is less than a threshold elliptical distance.

3. The method of claim 2, wherein adjusting the maximum transmit power level further comprises maintaining or reducing the maximum transmit power level when the elliptical distance exceeds the threshold elliptical distance.

4. The method of claim 2, wherein the elliptical distance is defined, on a complex plane, between the VSWR measurement and a center of the reference set of VSWR values.

5. The method of claim 4, wherein the VSWR values in the reference set are enclosed within an ellipse in the complex plane, the ellipse is associated with the threshold elliptical distance, and the center of the reference set is located at a center of the ellipse.

6. The method of claim 1, wherein:
the maximum transmit power level has a first value during a first time period,
the VSWR measurement is performed during the first time period,
the maximum transmit power level has a second value during a second time period after the first time period, and
adjusting the maximum transmit power level comprises increasing the maximum transmit power level from the first value to the second value.

7. The method of claim 6, wherein the second value corresponds to a highest maximum transmit power level supported by the antenna.

8. The method of claim 6, wherein the reference set of VSWR values is associated with the antenna operating in a free space environment.

9. The method of claim 8, wherein the reference set of VSWR values comprises a cluster of VSWR measurements that are performed by the wireless circuitry and that are stored on the wireless circuitry during an initial calibration of the wireless circuitry.

10. The method of claim 1, wherein the elliptical distance is proportional to a square root of an inverse of a covariance of the reference set of VSWR values.

11. The method of claim 10, wherein the elliptical distance is proportional to the square root of the inverse of the covariance of the reference set of VSWR values multiplied by a quantity, the quantity being equal to the VSWR measurement minus a mean of the reference set of VSWR values.

12. The method of claim 1, wherein the elliptical distance comprises a Mahalanobis distance.

13. The method of claim 1, wherein the VSWR measurement is performed during a first time period and the method further comprises:
updating, using the one or more processors, the reference set of VSWR values to include the VSWR measurement, wherein the VSWR measurement has an amplitude that differs from an amplitude of the reference set of VSWR values by less than a threshold amount and has an angle that differs from an angle of the reference set of VSWR values;
performing, using the sensor, an additional VSWR measurement based on the radio-frequency signals during a second time period after the first time period; and
performing, using the one or more processors, an additional adjustment to the maximum transmit power level based on an additional elliptical distance between the additional VSWR measurement and the updated reference set of VSWR values.

14. Wireless circuitry comprising:
a transmitter configured to transmit radio-frequency signals over a transmission line path while subject to a maximum transmit power level backoff;
a voltage standing wave ratio (VSWR) sensor coupled to the transmission line path and configured to perform a VSWR measurement based on the radio-frequency signals; and
one or more processors communicatively coupled to the VSWR sensor and the transmitter, the one or more processors being configured to
reduce the maximum transmit power level backoff of the transmitter responsive to a distance between the VSWR measurement and a reference cluster of VSWR values being less than a threshold.

15. The wireless circuitry of claim 14, wherein the distance comprises an elliptical distance, on a complex plane, between the VSWR measurement and a center of an ellipse associated with the threshold, the cluster of VSWR values being within the ellipse on the complex plane.

16. The wireless circuitry of claim 14, wherein the distance comprises a Mahalanobis distance.

17. The wireless circuitry of claim 14, the one or more processors being further configured to:
maintain or increase the maximum transmit power level backoff of the transmitter responsive to the distance between the VSWR measurement and the reference cluster of VSWR values exceeding the threshold.

18. A method of operating wireless circuitry, the method comprising:
transmitting, using a transmitter while subject to a maximum transmit power level, radio-frequency signals over an antenna;
performing, using a sensor while the antenna is in an occluded state, a voltage standing wave ratio (VSWR) measurement based on the radio-frequency signals;
detecting, using one or more processors, whether the antenna remains in the occluded state or has transitioned to a free space state based on a comparison of the VSWR measurement to a reference cluster of VSWR values associated with the free space state;
increasing, using the one or more processors, the maximum transmit power level responsive to detecting that the antenna has transitioned to the free space state; and
updating, using the one or more processors, the reference cluster of VSWR values to include the VSWR measurement responsive to detecting that the antenna remains in the occluded state.

19. The method of claim 18, wherein the VSWR measurement is one of a set of VSWR measurements performed using the sensor while the antenna is in the occluded state and wherein updating the reference cluster of VSWR values comprises:
generating an updated reference cluster of VSWR values for use in detecting a transition of the antenna between the occluded state and the free space state;
including, in the updated reference cluster, a subset of VSWR measurements from the set of VSWR measurements, wherein the subset of VSWR measurements have a Mahalanobis distance from a center of the reference cluster of VSWR values that exceeds a threshold distance; and
validating the updated reference cluster based on a factory reference cluster of VSWR values measured during an initial calibration of the wireless circuitry, based on a mean of the updated reference cluster, and based on a covariance of the updated reference cluster, wherein the factory reference cluster of VSWR values is associated with the free space state.

20. The method of claim 18, wherein the VSWR measurement is one of a set of VSWR measurements performed using the sensor while the antenna is in the occluded state and wherein updating the reference cluster of VSWR values comprises:
performing a density-based spatial clustering of applications with noise algorithm on the set of VSWR measurements to generate an updated reference cluster of VSWR values that is used in detecting a transition of the antenna between the occluded state and the free space state.
